(19) United States
(12) Patent Application Publication
(10) Pub. No.: US 2013/0116604 A1
(43) Pub. Date: May 9, 2013

(54) CONTROLLED-SUSPENSION STANDING DEVICE FOR MEDICAL AND VETERINARY USE

(71) Applicants: Horacio Alberto MORILLA, Pcia de Buenos Aires (AR); Rosa Virginia RUGIERO, Pcia de Buenos Aires (AR); Jorge Alberto FANTIN, Ciudad de Buenos Aires (AR); Graciela Ines SILVA, Ciudad de Buenos Aires (AR)

(72) Inventors: Horacio Alberto MORILLA, Pcia de Buenos Aires (AR); Rosa Virginia RUGIERO, Pcia de Buenos Aires (AR); Jorge Alberto FANTIN, Ciudad de Buenos Aires (AR); Graciela Ines SILVA, Ciudad de Buenos Aires (AR)

(21) Appl. No.: 13/291,274

(22) Filed: Nov. 8, 2011

(51) Int. Cl. A61H 1/02

(52) U.S. Cl. 601/33

(57) ABSTRACT

The present invention relates to the field of supporting arrangements, devices or systems for the rehabilitation and treatment of patients or animals suffering from motor disabilities resulting from surgery, chronic disorders, accidents and the like. More specifically, the present invention refers to aerial or overhead supporting arrangements, devices or systems that allow the patient or animal under treatment to remain suspended.

### FIELD OF INVENTION

The present invention relates to the field of supporting arrangements, devices or systems for the rehabilitation and treatment of patients or animals suffering from motor disabilities resulting from surgery, chronic disorders, accidents and the like. Preferably, the present invention refers to aerial or overhead supporting arrangements, devices or systems that allow the patient or animal under treatment to remain suspended.

### DESCRIPTION OF PRIOR ART

The state of the art concerning devices that are helpful for human patients suffering from motor disabilities basically comprises two well-distinguished family of products: certain cranes that allow patients to be lifted and transferred to a different place, such as on a bed or wheelchair, and from a wheelchair into a bathtub or on a therapy table.

In effect, U.S. Pat. No. 3,780,663A refers to an ambulatory system for use by debilitated ambulatory patients and the like. The system consists of a track network including a primary track, which extends the length of communicating corridors, and a plurality of secondary tracks, each extending from a point in close proximity with the primary track, and terminating at a point remote therefrom, and a travelling truck, supported by the track network, having a harness depending therefrom for substantially supporting the weight of a human body in suspension for assisting the patients in walking along the corridors as well as to enter and depart from various areas through which the secondary tracks are extended.

This system allows only a forward-and-backward unidirectional track along the rails where the same are installed. This system is not viable for travelling along the x-y plane in any direction within a particular area, such as a recovery room. The arrangement cannot be regulated as desired when used with the applied load. The harness is provided for human patients but not for animals under recovery treatment. Therefore, it is desirable to have a device allowing both ambulatory human and animal patients to be ad lib transported within a given area with controlled load and without any track restrictions. The harness and the supporting bar comprising four lifting points with two front lifting points spaced from two rear lifting points, provide greater support to the back of the patient and facilitate the entry and removal of the patient. A solid state motor control allows easy control of the speed of the motor for the patient lift system. In other features, the motor control incorporates a remote control which provides a safer use of the device. The sling or harness may also comprise a support for the patient's head.

U.S. Pat. No. 6,315,138 B1 refers to an overhead support system. A riding surface is located over a space and supports at least one overhead cart from which a load is supported by a tension element. A plurality of spherical elements is positioned between the riding surface and overhead cart and is attached to either the cart or the riding surface. The load can be moved horizontally in the space by applying a horizontal force to the load causing the cart to move over the riding surface while carrying the load in the horizontal direction. In preferred embodiments, the riding surface is an array of spoked rimless wheels. In other preferred embodiments the riding surface is a slot track, or a combination thereof. In other preferred embodiments a hoist assembly is used to raise and lower the load, which may be located below or above the riding surface. In preferred embodiments casters are mounted on the top of the riding surface to permit easy horizontal movement of the cart over the casters. In other preferred embodiments the riding surface is flat and casters are mounted on the bottom of the overhead cart and above the patient's head.

Patent Application GB 1092926 refers to a hoisting device for invalids and the disabled which comprises a casing that houses an electric-motor driven shaft to raise and lower a cable wound on the shaft, the remote end of the cable being attached to an invalid harness. The motor which drives the shaft through reduction gearing is operable forward or reverse either by cords coupled to switches in the casing, or by a switch box held by the invalid. A motor switch on the casing is operated by the top of the harness in the case of overwind. The casing is pivotally connected to a wheeled table running in rails. The table is moved along the rails either manually or by motor driven endless cable. In a further embodiment the hoisting motor is controlled by a suck-blow switch valve operated from the invalid's mouth.

Document DE 3432045 A1 refers to an overhead transporting device comprising a frame that can be moved along a rail or track. This frame is suspended from the track by two wheel systems and is driven by a friction roller. The weight of the frame and its accessories and the weight of the load that can be suspended from a transporting harness cause the frame to turn on the wheels near the friction roller because the friction roller is pressed against the track based on the load. The friction roller is driven by an electric motor fed by an electric motor installed on the frame.

On the other hand, there are standers which, based on a totally different operation principle, allow human patients to stand on their two legs when the patient is placed on a fixed platform, by securing the patient with belts and other fixing or attaching means. However, these standers or standing devices do not allow them to walk, either alone or with assistance.

Therefore, there is a need for a device that will allow human patients or animals to receive a practical and safe rehabilitation therapy, or a device that will allow irreversibly disabled patients to exercise or walk within a given area without restriction or partially without assistance, such devices being easy to handle.

Likewise, said device is desirably and indistinctly also intended for use in veterinary medicine for the rehabilitation and exercise of animals of different sizes that may be in need thereof.

### SUMMARY OF THE INVENTION

Therefore, it is an object of this present invention to provide a standing device for human or animal patients that need treatment and/or rehabilitation, which comprises: two fixed parallel rails on which two movable parallel rails are movably and freely linked thereto by wheels in a forward-backward direction (axis y) and perpendicular to the former ones, and a base structure on the assembly of movable parallel rails movably and freely linked thereto by wheels in a right-left direction (axis x), the base structure comprising an electric motor operated by remote control from which a cable is suspended with a harness attached thereto according to the physical and medical characteristics of the human or animal patient under treatment.

Preferably, the base structure movably linked to the system of parallel rails by means of wheels allows the left-to-right movement (axis x) to be transmitted to the system consisting in motor, wire, hook, eventually an intermediate hanger, harness and human or animal patient under treatment along the movable parallel rails.

The dynamometer serially disposed, between the motor and the human or animal patient under treatment, allows measuring the load applied thereon at any time.

More preferably, the standing device facilitates the combined three-dimensional movement as desired, allowing a free left-to-right or vice versa movement and the forward-to-backward or vice versa movement and an upward-to-downward or vice versa controlled movement by human or animal patients with motor disabilities caused by neurological, orthopedic or rheumatic disorders, and which device is intended for treatment and/or recovery from said disorders and comprises:

a pair of parallel fixed rails;

a pair of parallel movable rails mounted by means of wheels on parallel fixed rails; and

an electric motor mounted on a movable base structure which is supported by wheels on movable parallel rails and which shaft is attached to a wire from which a dynamometer and a harness are suspended, the electric motor being remotely operated.

Preferably, the two fixed rails are parallel installed on both corners of a room in a “forward-backward” direction.

More preferably, the fixed rails and the parallel movable rails have grooves which facilitate the passing of several wheel systems throughout its length.

Even more preferably, the parallel fixed rails are installed in the room by a plurality of perpendicular attachments which link the ceiling to said rails.

Even more preferably, the two movable rails are parallel mounted and linked to at least two rigid metal pieces to secure such parallel condition, where the rigid metal pieces fix the ends of said movable rails.

Preferably, said rigid metal pieces comprise a beam or bar joined to two end couplings that are fixed to the ends of each of said movable rails, the movable rails and both rigid pieces thereby essentially forming a rectangle.

Also preferably, the movable rails are linked to the rigid pieces by fixing means selected from the group consisting of couplings and welding means, couplings and screws, couplings and pins, and combinations thereof.

Preferably, the movable rails intercept the fixed rails at a 90° angle.

Also preferably, at both ends of each movable rail there is a plurality of wheels that supply movement to the movable rails along the entire track allowed by the parallel fixed rails, where the wheel systems are fixed to the ends of the rigid pieces that keep the movable rails parallel.

Even also preferably, a plurality of wheels is installed on the ends of the electric motor base structure in order to allow displacement thereof along grooves of the movable rails.

Preferably, the base structure of the electric motor consists in a painted plate having essentially the shape of a casing, and which is mounted below the parallel movable rails and linked thereto by wheels allowing the movement of the system formed by the motor base structure, the electric motor, the motor remote control, the wire with a hook on its end, eventual intermediate holding hanger, harness and human or animal patient along grooves or channels of the movable rails.

More preferably, the wire is a steel wire.

Even more preferably, the electric motor is mounted within the casing being the base structure of the electric motor.

Still more preferably, the electric motor is controlled by a remote device which allows controlling the upward and downward movement of the wire, to which a hanger is attached by a hook, and from which a harness or slinger is suspended or a harness is also directly suspended without intermediate hanger.

Still more preferably, the dynamometer is placed between the wire hook and the intermediate hanger or harness.

Preferably, the remote control system is a remote control.

More preferably, the speed control of the electric motor comprises a mechanic speed reducer, an electronic reducer or a combination of both.

Even also more preferably, the motor is fed with a single-phase voltage of 110 Volt to 220 Volt.

Even more preferably, the remote control has an applied voltage of 12 Volt obtained by reducing single-phase voltage of 110 Volt to 220 Volt.

Still more preferably, the end of the motor shaft or the mechanical speed reducer comprises a pulley through which the wire is passed.

Preferably, the dynamometer is a digital dynamometer.

More preferably, the dynamometer comprises a memory that stores the data of each patient for each session, or a transmitter that said data to a storage terminal.

Preferably, the harness for a human patient is selected from the group consisting of: standing device harness which fastens the legs by the groin and fastens the trunk in order to keep the body in upright position, standing device harness with leg and trunk fasteners to keep the body in upright position, ergonometric harness for a standing device with trunk fasteners, stepping tables, backboard tables, ergonometric articulated harness, vestibulation harness with pelvic girdle holder, vestibulation harness with trunk holder, vestibulation swing harness, equine therapy harness, vestibulation bolster, jacket-diaper harness, and permanent transportation harness.

The standing device harness with leg fasteners by the groin and trunk fasteners for keeping the body in upright position comprises a substantially rectangular panel that encloses the trunk of the human patient with a plurality of fastening belts, two top side couplings or hooks with attachments on the front and back border of the panel, and two groin fastening belts below which cover the crotch, where the side couplings are coupled to an intermediate hanger that is suspended from the supporting hook linked to the lifting motor by a wire pulley.

The standing device harness with leg and trunk fasteners for keeping the body in an upright position comprises a substantially rectangular panel that encloses the patient's trunk and a plurality of fastening belts, two top side couplings with mounting parts on the front and back border of the panel, and two lower pair of lines one in the front and the other at the back of each pair, which end in two substantially rectangular panels that enclose the patient's legs and fasten them by at least two fastening belts that cover the groin and prevent slipping from the trunk fasteners, where side couplings are coupled on a hanger that is suspended from the supporting hook linked to the lifting motor by a wire pulley.

The standing device ergonometric harness with trunk fasteners comprises a substantially trapezoid panel that encloses the patient's trunk and forms substantially a cone, where the panel comprises a plurality of fastening belts, two top side couplings with attachments on the front and back panel borders, where side couplings are suspended on a hanger from the supporting linked to the lifting motor by a wire pulley.

The harness of a stepping table comprises a substantially rectangular panel with hems on the borders through which two beams are passed with a hinge in the middle and at least two supporting rings at equal distance from the ends, where said hems comprise notches that lead to said hinges and rings from which handle couplings are attached, said handles being parallel to the beams and holding a table suspended from a hook linked to the lifting motor by a wire pulley.

The harness of a backboard table comprises a substantially rectangular panel with border hems through which two beams are passed which comprise at least two supporting rings at the same distance from the ends, said hems comprising notches that exhibit the rings from which handle couplings are attached parallel to the beams and from which a table is suspended from a supporting hook linked to the lifting motor by a wire pulley.

The articulated ergonometric harness comprises two substantially rectangular independent panels of about the same surface, on which ends line ends are fixed which end at the supporting rings, where both panels enclose the patient and hang from the rings from a supporting hook linked to the lifting motor by a wire pulley.

The vestibulation harness holding the pelvic girdle comprises a substantially rectangular base panel which extends through longitudinally opposite ends of one of its sides with at least two lines, where said side is projected beyond the lines and extends from the side opposite to the former one and projects two substantially triangular panels which end in at least one line each, where each line ends at a plurality of supporting rings which allow selecting the best attachment means for the harness/patient assembly, and where the patient is sitting on the base panel supporting him/her by the pelvic girdle and the two substantially triangular panels are crossed on the front and through the groin for lifting the harness/patient assembly, the harness and the patient being suspended by the holding rings on a hanger suspended from the supporting hook linked to the lifting motor by a wire pulley.

The vestibulation harness for trunk fastening comprises a substantially rectangular base panel which extends through the longitudinally opposed ends of one of the sides thereof with at least two lines, while said side extends along the panel from which two lines are projected, so that between said end lines taken in pairs a passage for the patient's arms is created which projects from the side opposite the former one and projects two substantially triangular panels which end in at least one line each, where each line ends on a plurality of holding rings which allow selecting the best attachment means for the harness/patient assembly, and where the patient is sitting on the base panel holding the patient by his/her chest and pelvic girdle and the substantially triangular two panels are crossed on the front thorough the groin for lifting the harness/patient assembly, the harness/patient being suspended by the holding rings on a hanger that is suspended from the supporting hook linked to the lifting motor by a wire pulley.

The swing harness comprises a substantially rectangular base which forms a recessed surface as supported by two substantially triangular sides which lower base, through which they are linked to the bottom, is curved and ends upwards on corresponding rings for hanging the assembly, where the substantially triangular sides comprise radially disposed reinforcing straps, and the rings for hanging the assembly are suspended from a single supporting hook linked to the lifting motor by a wire pulley.

The equine therapy harness comprises two portions: a top portion formed by a substantially rectangular panel at which ends lines are attached and end at supporting rings, and a lower portion comprising two substantially rectangular equivalent panels linked to each other by a “V” shaped-attached single line, on which corner there is a ringer and corresponding lines fixed to the remaining ends of the panels which also end in a ring, where both harness portions, once the top panel is passed across the back of the patient and each lower portion panel is passed behind the patient's legs, are suspended by the rings on a uniform pattern and at the level of the patient's chest from a holding hook linked to the lifting motor by a wire pulley.

The harness is a bolster for vestibulation comprising a cushioned cylinder with hard covers at its ends where two side outlet lines are fixed on each end of the bolster, which are joined on their upward track by at least two cross-sectional grips or handles and concur in a single ring for each end, where the bolster ends in substantially round covers where line ends are internally fixed to be directed to the sides from which they come out of said bolster, and where the bolster is suspended from said rings by a hanger ad hoc for use in vestibulation exercises, said hanger being supported by a hook linked to the lifting motor by a wire pulley.

The jacket-diaper harness comprises a jacket that encloses the patient thorax that is closed on the front by two lines that end in corresponding closing hooks, while a lower projection of the jacket goes down behind the patient and is attached to the front of said jacket by at least two lines with corresponding closing hooks, where the jacket straps comprise lines ending on the rings to be attached to the hanger fasteners, which hanger is held by a central ring on a supporting hook linked to the lifting motor by a wire pulley.

The permanent-transportation harness comprises a substantially rectangular panel with rounded ends, wherein at least one of the said ends has a reinforcing means and the other includes a longitudinal cut which, once sewed, creates a closure which causes a recessed patient holder, and where lines extend from each harness vertex, which lines end in a plurality of rings from which the harness is suspended by a supporting hook linked to the lifting motor by a wire pulley.

Preferably, harnesses are manufactured with hypoallergenic vinyl canvas o neoprene and the lines are made of nylon fabric.

The harness for a quadruped animal patient comprises several supporting points for the animal weight, which distribute said weight and comprise several portions: a substantially rectangular ventral supporting assembly consisting in a plurality of layers of different kind and materials, where at least two independent inflatable receptacles are placed between them with multiple cavities reciprocally related to two longitudinally extending and interconnecting conduits, where said cavities are transversally and parallel disposed in an alternate pattern and cover the entire surface of the supporting assembly, where said cavities and conduits retain the air.

Preferably, the plurality of layers of the ventral supporting assembly of the harness for a quadruped animal patient comprise, from the inner layer in contact with the animal patient up to the outer surface: a first basically-cotton fabric layer, of a canvas or denim/jean kind; a second layer made of felt, preferably made of wool fibers; a third layer formed by polyurethane foam rubber; a fourth layer formed by at least two independent inflatable receptacles with multiple cavities linked to each other, constituted by a gas-proof film or fabric; a fifth layer formed by polyurethane foam rubber; a sixth layer formed by felt, preferable made of wool fibers; a seventh layer of basically wool fabric, of a canvas or denim/jean kind; and an eighth layer formed by a wound fabric with alternate intercrossed lines where a plurality of lines project and end in the supporting rings, said lines being preferably of a nylon or like fabric, and where the different layers are sewed one to the other as a whole assembly.

Also preferably, the plurality of side lines ending on corresponding supporting rings of said ventral supporting assembly is fixed to the bearings of a supporting frame.

Additionally, the harness for a quadruplet animal patient comprises four substantially conical sleeves for supporting forearms and thighs of the animal patient, each sleeve comprising at least two lines ending on the corresponding supporting rings for fixing the sleeves to the supporting frame.

Preferably, the sleeves are made of rubber fabric and polyurethane, and the lines are made of knitted nylon.

In a preferred manner, the supporting frame is formed by a series of beams and bearings being the corners and vertex of a regular prism with substantially rectangular base and sides and which front and rear faces are substantially triangular, where the longitudinal beams comprise a plurality of supporting grommets for fixing the supporting rings of the ventral supporting assembly and the sleeves, and above, at least a supporting grommet for hanging the assembly from a supporting hook linked to the lifting motor by a wire pulley Also preferably, the multiple cavities of the inflatable receptacles are filled with compressed air by means of at least one compressor, where the valves at the inlet of each conduit allow the air to enter and exit in a predetermined manner, thereby increasing and reducing the pressure within each receptacle.

Preferably, the compressor has a compression capacity of 75 to 100 pounds/square inch and compresses air continuously on the valves, which alternatively release a pressure of about 14/pounds/square inch every 3/10 minutes on a predetermined pattern in order to prevent the air release and to allow the air inlet so as to recover the pressure by starting a new cycle.

Also preferably, the inflatable receptacles are made of a resistant and air-retaining material selected from waterproof nylon fabric and a polyvinyl film, such as Panaflex.

In a preferred manner, the animal patient for which the harness is intended is an equine.

It is another object of the present invention to provide a harness for the treatment and/or recovery of an equine, which comprises several supporting points for the distributed weight of the animal, and which comprises several portions: a ventral supporting assembly which is substantially rectangular and consists in a plurality of layers of different kind and material, there being at least two independent inflatable receptacles between said layers, which receptacles comprise multiple cavities mutually linked to two interconnecting longitudinal conduits, and where said cavities are transversally and parallel disposed, in an alternate pattern, and cover the entire surface of the supporting assembly, where said cavities and conduits retain the air.

Preferably, the plurality of layers of the ventral supporting assembly of the harness for a quadruplet animal patient comprise, from the inner layer in contact with the animal patient up to the outer surface: a first basically-cotton fabric layer, of a canvas or denim/jean kind; a second layer made of felt, preferably made of wool fibers; a third layer formed by polyurethane foam rubber; a fourth layer formed by at least two independent inflatable receptacles with multiple cavities linked to each other, constituted by a gas-proof film or fabric; a fifth layer formed by polyurethane foam rubber; a sixth layer formed by felt, preferably made of wool fibers; a seventh layer of basically wool fabric, of a canvas or denim/jean kind; and an eighth layer formed by a wound fabric with alternately intercrossed lines where a plurality of lines project, which end in the supporting rings, said lines being preferable of a nylon or like fabric, and where the different layers are sewed one to the other as a whole assembly.

Also preferably, the plurality of side lines ending on corresponding supporting rings of said ventral supporting assembly is fixed to the bearings of a supporting frame.

Additionally, the harness for a quadruplet animal patient comprises four substantially conical sleeves for supporting forearms and thighs of the animal patient, each sleeve comprising at least two lines ending on the corresponding supporting rings for fixing the sleeves to the supporting frame.

Preferably, the sleeves are made of rubber fabric and polyurethane, and the lines are made of knitted nylon.

In a preferred manner, the supporting frame is formed by a series of beams and bearings being the corners and vertex of a regular prism having substantially rectangular base and walls and which front and rear faces are substantially triangular, where the longitudinal beams comprise a plurality of supporting grommets for fixing the supporting rings of the ventral supporting assembly and the sleeves, and above, at least a supporting grommet for hanging the assembly from a supporting hook linked to the lifting motor by a wire pulley.

Also preferably, the multiple cavities of the inflatable receptacles are filled with compressed air by means of at least one compressor, where the valves at the inlet of each conduit allow the air to enter and exit in a predetermined manner, thereby increasing and reducing the pressure within each receptacle.

Preferably, the compressor has a compression capacity of 75 to 100 pounds/square inch and compresses air continuously on the valves, which alternatively release a pressure of about 14/pounds/square inch every 3/10 minutes on a predetermined pattern in order to prevent the air release and to allow the air inlet to recover the pressure by starting a new cycle.

Also preferably, the inflatable receptacles are made of a resistant and air-retaining material selected from waterproof nylon fabric and a polyvinyl film, such as Panaflex.

### BRIEF DESCRIPTION OF THE FIGURES

FIG. 1 shows a bottom perspective view of a preferred embodiment of the standing device that allows the combined three-dimensional movement.

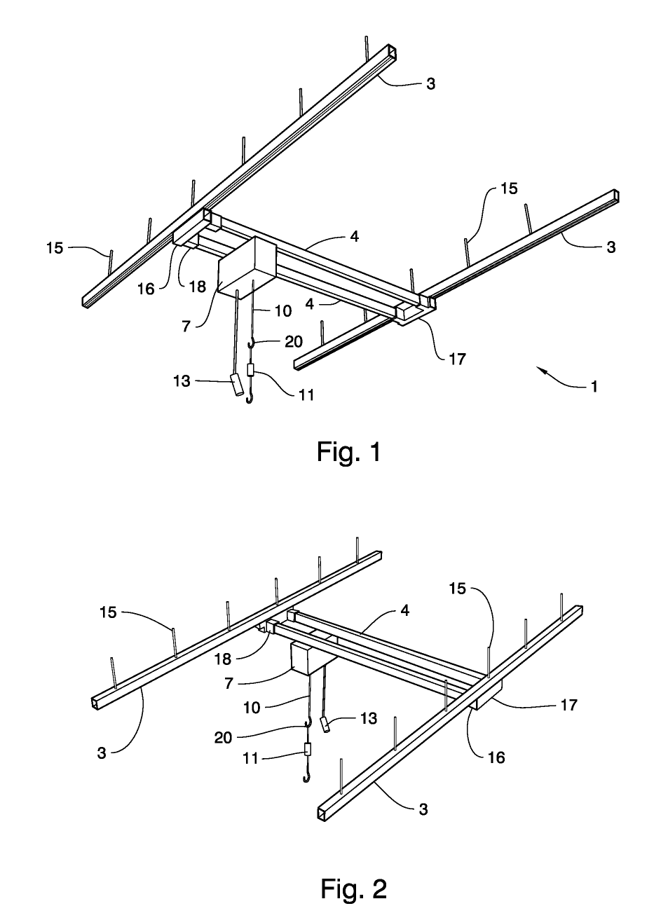

FIG. 2 shows a top perspective view of a preferred embodiment of the standing device of FIG. 1.

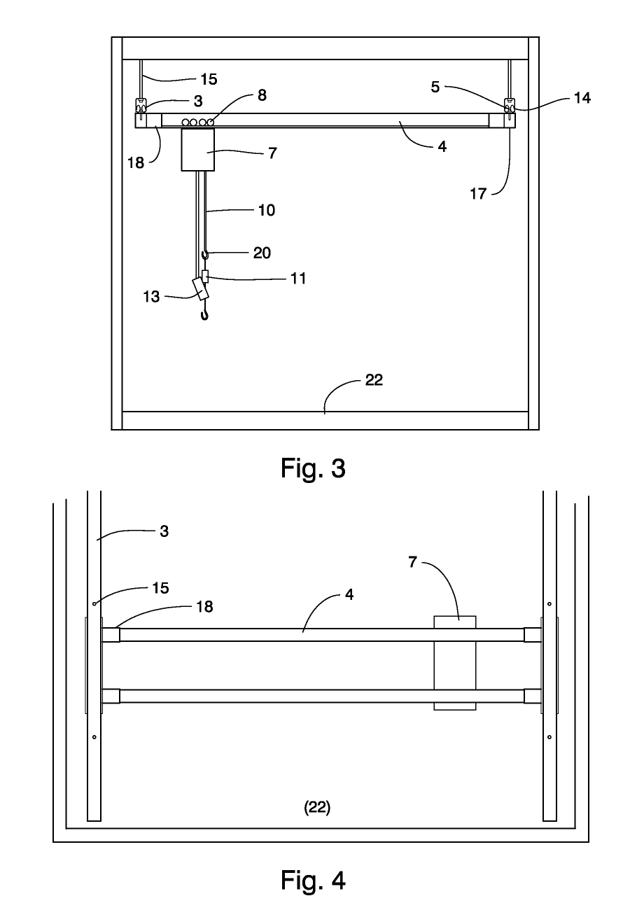

FIG. 3 shows a front view of a preferred embodiment of the standing device of FIG. 1.

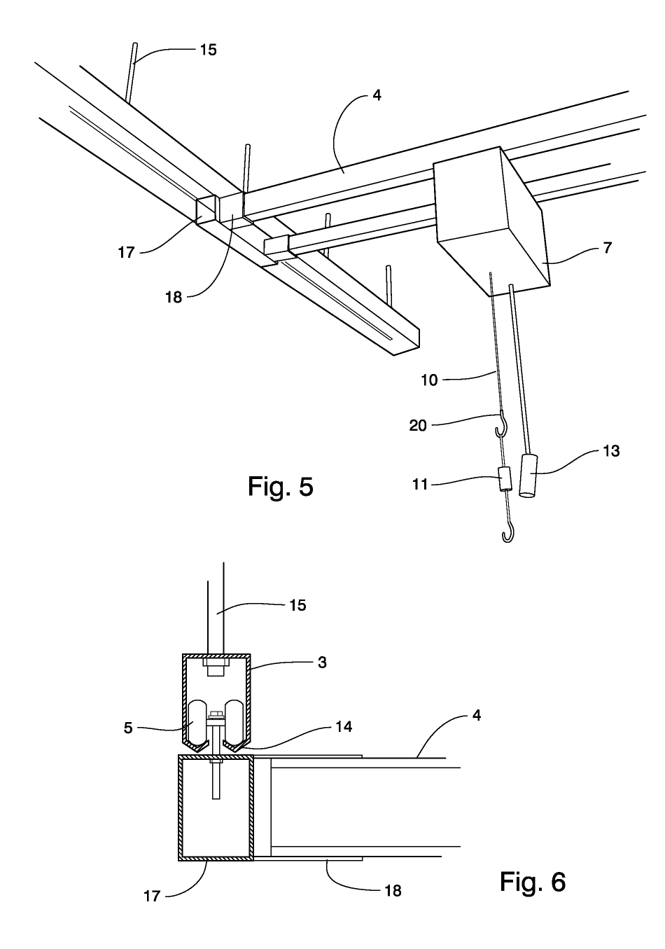

FIG. 4 shows an upper plan view of a preferred embodiment of the standing device of FIG. 1.

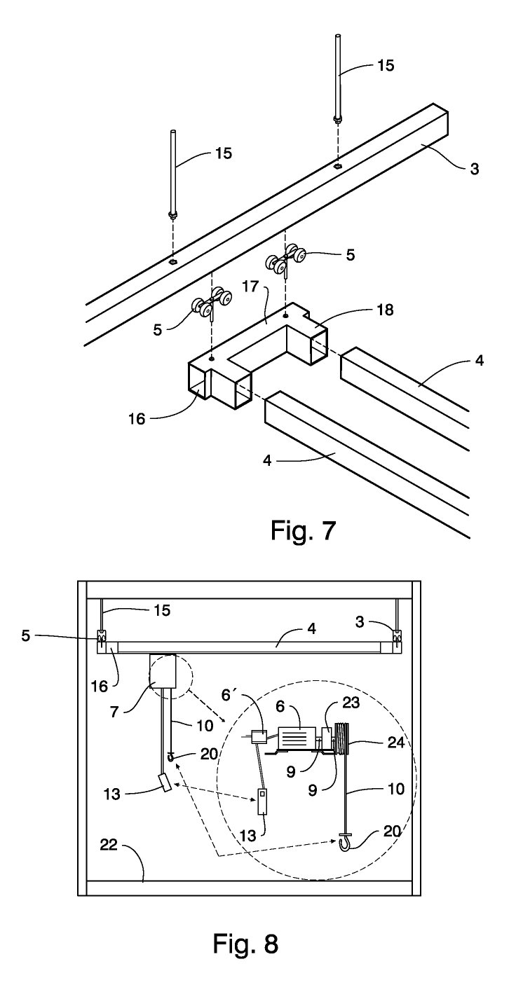

FIG. 5 shows a bottom perspective view of a detailed preferred embodiment of the standing device of 1.

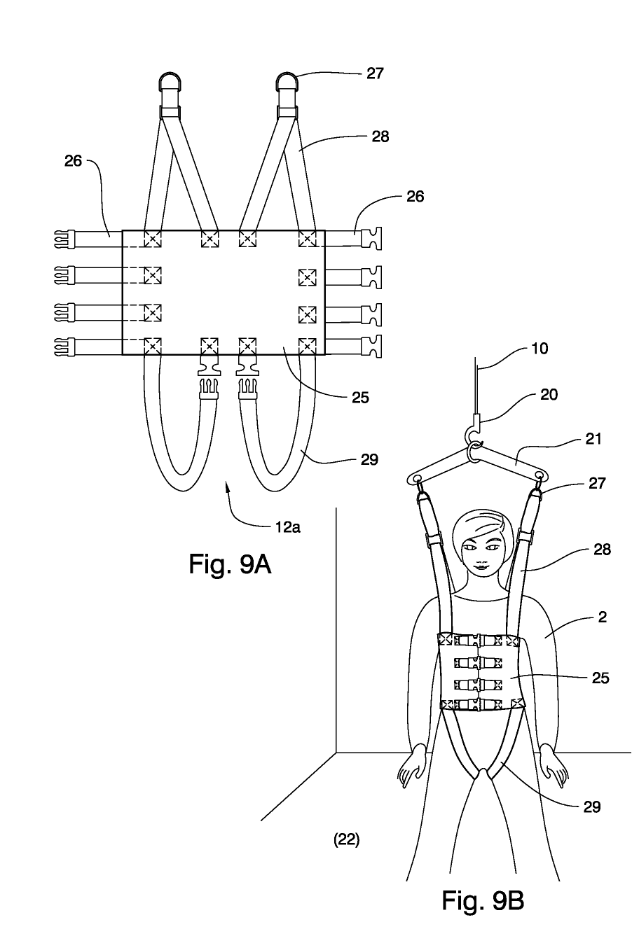

FIG. 6 shows a cross-section view of one of the parallel rails fixed with one of the upper fastenings and a system of wheels which allow the movement of the pair of movable parallel rails belonging to a preferred form of embodiment of the standing device of FIG. 1.

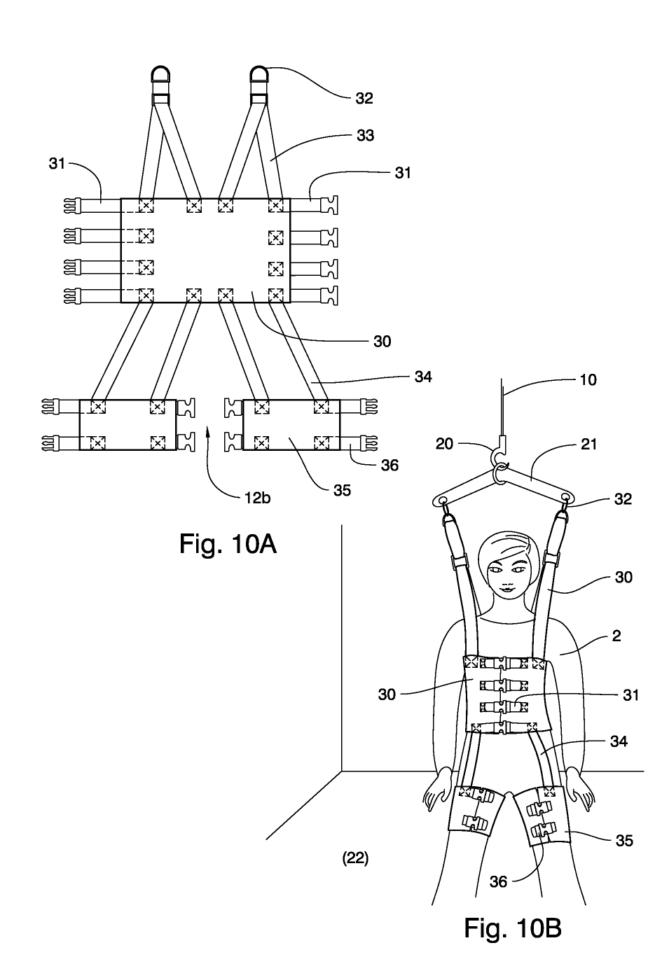

FIG. 7 shows an expanded perspective view of one of the parallel rails fixed by upper fasteners and systems of wheels allowing the movement of the pair of movable parallel rails belonging to a preferred form of embodiment of the standing device of FIG. 1.

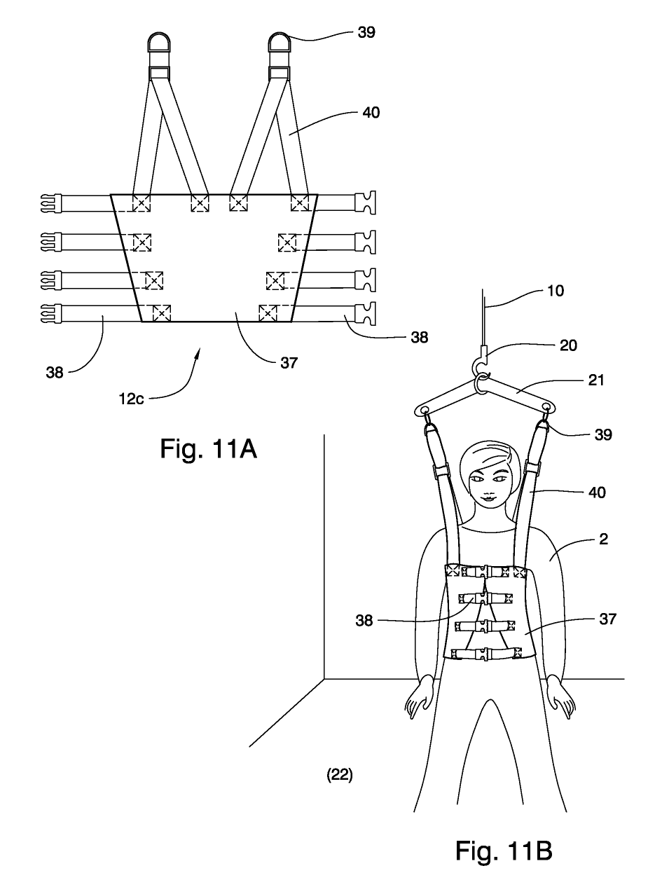

FIG. 8 shows the inner part of the casing with an electric motor mounted on a movable base, which is supported by rollers on movable parallel rails, and which axis is linked to a mechanical speed reducer which ends at a pulley which winds a steel wire belonging to a preferred form of embodiment of the standing device of FIG. 1.

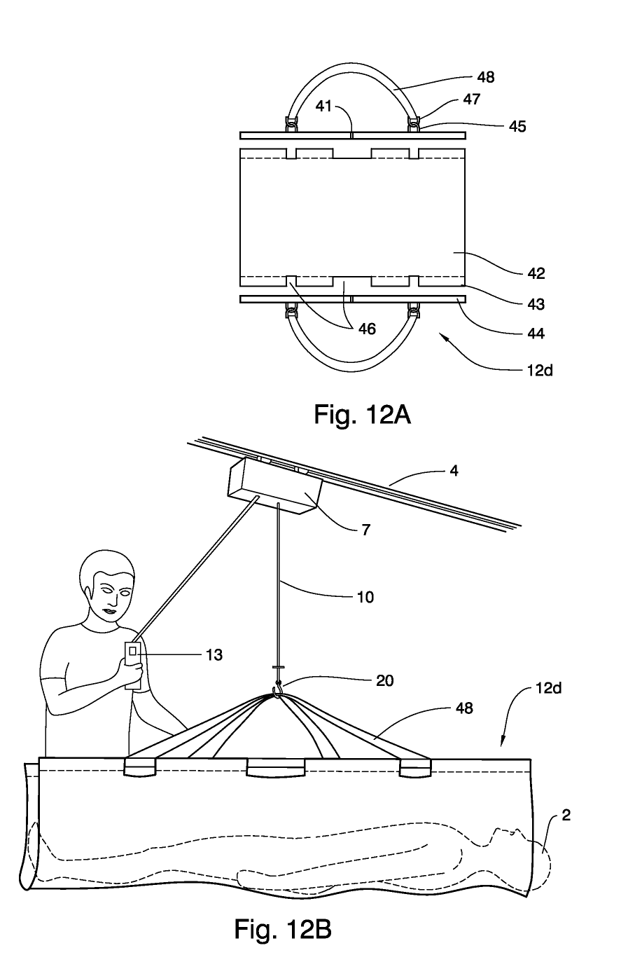

FIGS. 9A and 9B show a preferred form of embodiment of the standing device harness which fastens the legs by the groin and the trunk so that the patient may keep an upright position for use in the standing device of FIG. 1.

FIGS. 10A and 10B show a preferred form of embodiment of a harness for a standing device with leg and trunk fasteners so as to keep the patient in an upright position for use in the standing device of FIG. 1.

FIGS. 11A and 11B show a preferred form of embodiment of an ergonometric harness for a standing device with trunk fasteners for use in the standing device of FIG. 1.

FIGS. 12A and 12B show a preferred form of embodiment of a stepping panel table for use in the standing device of FIG. 1.

FIGS. 13A and 13B show a preferred form of embodiment of fixed panel table for use in the standing device of FIG. 1.

FIGS. 14A and 14B show a preferred form of embodiment of an ergonometric articulated harness for use in the standing device of FIG. 1.

FIGS. 15A, 15B and 15C show a preferred form of embodiment of a vestibulation harness with a pelvic girdle holder for use in the standing device of FIG. 1. FIG. 15B shows in detail a line with three supporting rings.

FIGS. 16A, 16B and 16C show a preferred form of embodiment of a vestibulation harness with a trunk holder for use in the standing device of FIG. 1.

FIGS. 17A and 17B show a preferred form of embodiment of a swing vestibulator for use in the standing device of FIG. 1.

FIGS. 18A and 18B show a preferred form of embodiment of a harness for equine therapy for use in the standing device of FIG. 1.

FIGS. 19A and 19B show a preferred form of embodiment of bolster for vestibulation for use in the standing device of FIG. 1.

FIGS. 20A and 20B show a preferred form of embodiment of a jacket-diaper harness for use in the standing device of FIG. 1.

FIGS. 21A and 21B show a preferred form of embodiment of permanent transportation harness for use in the standing device of FIG. 1.

FIG. 22 show an schematic rear perspective view of a preferred form of embodiment of a harness for equines, which bears the weight of the animal and distributes the same on several supports, for use in the standing device of FIG. 1.

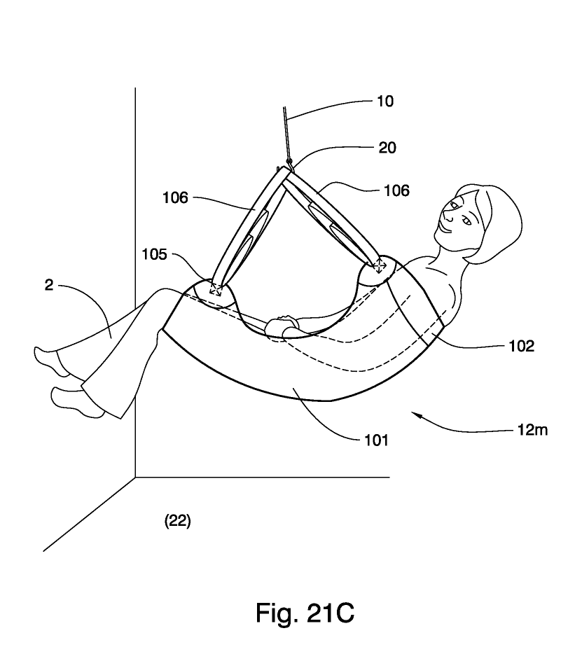

FIG. 23 shows a side and rear expanded perspective view of a preferred form of embodiment of the harness for equines of FIG. 22.

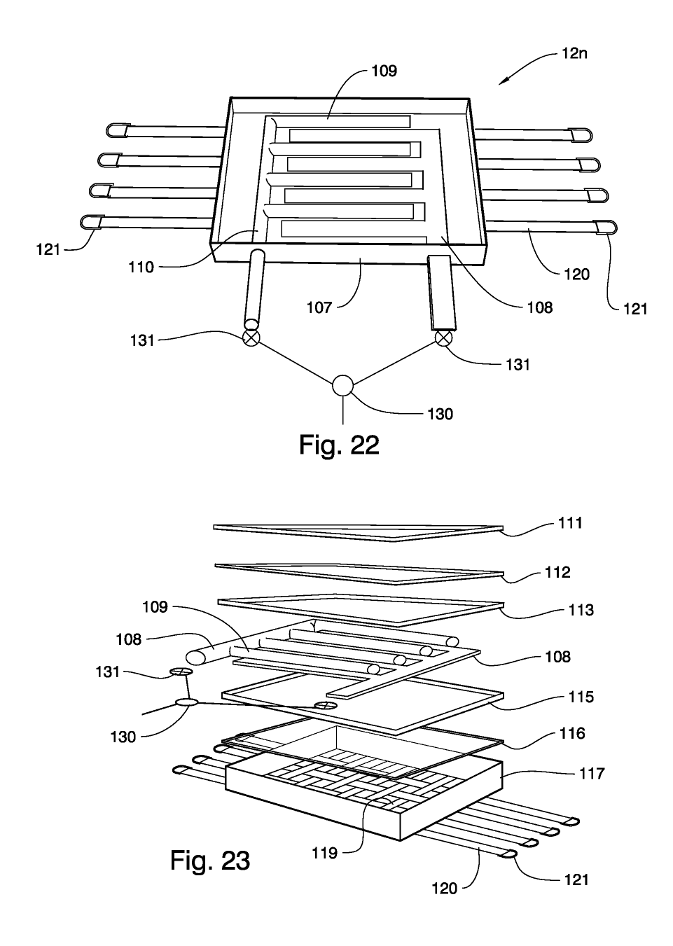

FIG. 24 shows a plain view of a preferred form of embodiment of alternate intercrossed lines forming the eighth layer of the harness for equines of 22.

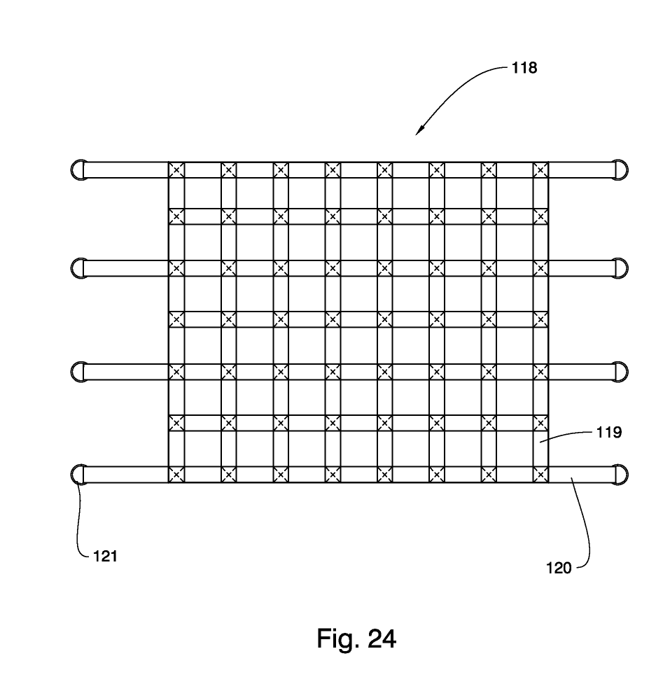

FIG. 25 shows a preferred form of embodiment of the harness for equines of FIG. 22 in use.

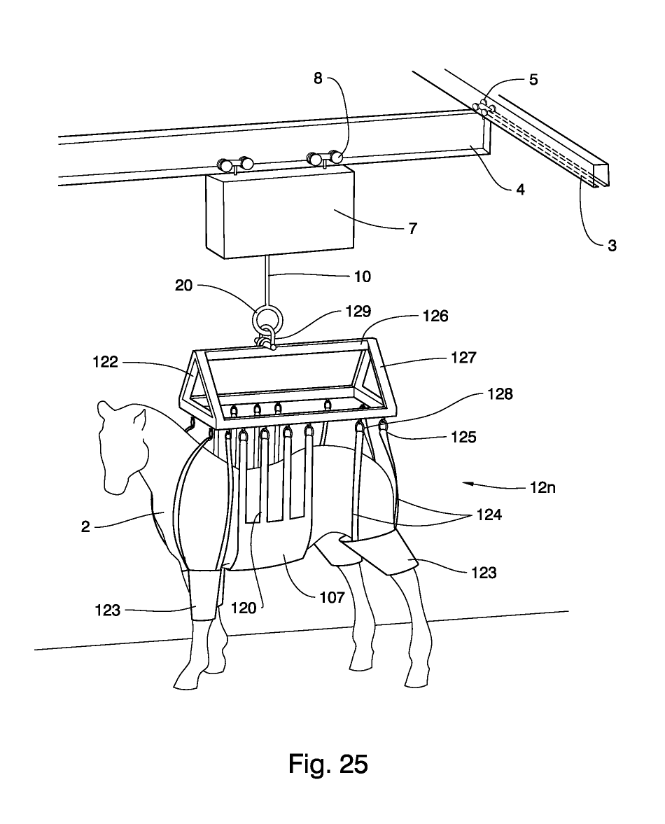

### DETAILED DESCRIPTION OF THE INVENTION

In order to find a solution to the technical problems above described, the present invention comprises a standing device (1) for the treatment and/or rehabilitation of patients (2) who are in need thereof, and which device comprises two fixed parallel rails (3) on which two movable parallel rails (4) can freely move on wheels (5) in a forward-backward direction (axis y) and are perpendicularly disposed with respect to the former. On the assembly of movable parallel rails (4) a base structure (7) is movably and freely linked thereto by wheels in a right-left direction (axis x) (8), which base structure comprises an electric motor which allows, by a remote control (13), lifting or lowering a wire (10) along a controlled upward-downward movement (axis z), with several kinds of harnesses (12) coupled on the end thereof, depending on the physical and medical features of the human or animal patient (2) under treatment.

The motor (6) is mounted on the movable base structure (7) with wheels (8) allowing transmission of the left-right movement (axis x) to the motor assembly (6), wire (10), hook (20), eventually an intermediate hanger (21), harness (12) and human or animal patient (2) under treatment along the movable parallel rails (4).

By harness (12) is meant any device allowing the patient to be lifted or suspended by action of the motor (6) of the standing device (1). Such harnesses may be of several kinds, either fastened to the body or involving suspension or support, depending on the rehabilitation procedures to be followed.

Thus, the human or animal patient (2) under treatment can move freely, with our without assistance by a third party, in any of the above mentioned three directions: forward-backward (axis y) and right-left (axis x), in plane (x, y), which is done by the patient himself/itself while moving by his/its own means, and upward-downward (axis z), in which case a motor (6) is employed to implement said movement, either by the patient himself or by an assistant third party. A dynamometer (11) sequentially disposed between the motor (6) and the human or animal patient (2) under treatment allows measuring of the load applied thereon at any time.

It is therefore an object of the present invention to provide a standing device (1) which facilitates the combined movement in the three optional dimensions, thereby allowing a free left-to-right or vice versa movement and a forward-to-backward or vice versa movement, and the controlled upward-to-downward movement, by human or animal patients (2) with motor disabilities resulting from neurological, orthopedic or rheumatic disorders, and which device is intended for their treatment or rehabilitation comprises the following elements:

a pair of fixed parallel rails (3);

a pair of movable parallel rails (4) mounted by wheels (5) on the fixed parallel rails (3); and

an electric motor (6) mounted on a movable base structure (7) supported by wheels (8) on the movable parallel rails (4) and which shaft (9) is linked to a wire (10) from which a dynamometer (11) and harness (12) are suspended, the electric motor (6) being operated by remote control (13).

Pursuant to a preferred embodiment, the standing device of the present invention consists in the above mentioned elements, as follows: the two fixed rails (3) are parallel installed at both ends or corners of a room where the device (1) is to be installed, in a direction coinciding with the “forward-backward” direction of walking. These rails (3) are grooved so that they allow a group of several wheels (5) of the movable parallel rails (4) to move within the grooves or canals (14) throughout their length.

Preferably, the fixed parallel rails (3) are installed in the room by a plurality of perpendicular mounting parts (15) that link the ceiling to said rails (3).

On the other hand, the two movable rails (4) are parallel mounted, linked by at least two rigid metal pieces (16) to secure such parallel condition, which are preferably mounted to the ends of said movable rails (4).

Preferably, said rigid metal pieces (16) comprise a beam (17) joined to two couplings (18) at the ends thereof, which are fixed to the ends of each of the movable rails (4), an assembly of movable rails (4) and both rigid pieces (16) thereby forming substantially a rectangle. The movable rails (4) are linked to the rigid pieces (16) by mounting means known in the art, such as couplings and welding, couplings and screws, couplings and pins, etc.

These movable rails (4) are also grooved so as to allow several wheel assemblies (8) to move within the grooves or channels (19) throughout its length. These movable rails (4) are disposed so that they intercept fixed rails (3) at a 90° angle.

On both ends of each of the movable rails (4) there is a plurality of wheels (5) installed. These wheels are in charge of providing movement to the movable rails (4) along the entire track allowed by the fixed parallel rails (3). Preferably, the wheel assemblies (5) are fixed on ends of the rigid pieces (16) which keep the movable rails (4) in a parallel condition.

Likewise, other wheel assemblies (8) are installed on the ends of the base structure (19) of the electric motor (6) to allow the movement thereof along the grooves or channels (19) of the movable rails (4), thereby allowing “left-to-right” displacement.

In a preferred form of embodiment, the base structure (19) of the electric motor (6) consists in a painted plate structure having substantially the shape of a casing. This structure (19) is mounted below the movable parallel rails (4) and linked thereto by wheel assemblies (8) that allow the movement of the assembly formed by the base structure (19) of the motor, the electric motor (6), remote control (13) of the motor (6), wire (10) with a hook (20) on its end, eventual intermediate hanger (21) for fastening, harness (12) and human or animal patient (2) in a “left-to-right” direction. Preferably, the wire (10) is a wire (10) made of steel or the like.

The combined movement in a “forward-backward” direction and in a “left-to-right” direction allows the user or patient (2) of the standing device (1) to walk along the floor surface or plane (22) of the room where the device (1) has been mounted, in any direction he may choose. That means that the user or patient (2), either human or animal, can walk along the room (19) where the standing device (1) has been mounted in any desired direction, without any restriction as to a predetermined direction by reason of the geometry of the device itself (1), except for the maximum limits imposed by the size of the device (1) resulting from the size of the pair of fixed parallel rails (3) and/or the size of the room that finally determines the previously referred sizes.

Thus, the human or animal user or patient (2) can walk along the room in a transversal forth and back direction, in a clockwise or counter-clockwise round direction, in zig-zag, depending on the perimeter of the location (19), longitudinal or transversal forth and back direction, or any combination of the above, as desired, with a load on the legs or lower limbs determined by the hoisting applied by the electric motor (6).

The electric motor (6) with its power supply (6′) is mounted within the casing that constitutes the base structure (7) of the electric motor (6). This electric motor (6) is operated by a remote control (13), which controls the upward and downward movement of a wire, (10) preferably a steel wire or cable (10), to which a hanger (1) is attached by a hooker (20) from which a harness (12) is suspended, or a harness is directly suspended therefrom without an intermediate hanger (21). Preferably, a dynamometer (11) is placed between the wire (10) and the hanger (21) or harness (12).

Similarly, the remote control (13) can be a remote control which provides a more safe operation by facilitating the remote control of the device (1) by the human patient (2) himself or any person assisting the patient (2), either human or animal.

The speed of the shaft (9) of the electric motor (6) can be controlled by a mechanical speed reducer (23) or by an electronic reducer, or any combination thereof. Preferably, the motor (6) is fed by a single-phase voltage of 110 Volt or 220 Volt, but the remote control (13) has an applied voltage of 12 Volt achieved by reducing the line voltage of 110 Volt or 220 Volt applied to the motor (6).

The end of the shaft (9) of the motor (6) or mechanical speed reducer (23) comprises a pulley (24) through which a wire (10) is passed, preferably a steel wire, by which the load harness (12)/patient (2) load borne by the device is hoisted or lowered. The end of the wire (10) is attached and the pulley (24) winds and unwinds the wire (10) during the upward and downward movements of the load.

The wire (10) transmits the force exerted by the motor (6) to the individual or patient (2) fastened to the device (1) by the harness (12), which is selected as required depending on the medical or veterinary disorder to be treated. Thus, an “upward-downward” movement is achieved.

The dynamometer (11), that is sequentially installed between the hook (20) of the wire (10) and the coupling of the hanger (21) or directly the harness (12), allows measuring the weight of the patient (2), either human or animal, and, in turn, to distribute the weight supported by the limbs during the treatment or rehabilitation therapy. This weight measuring mechanism allows working with a full control of the load applied to the human or animal patient (2). Preferably, the dynamometer (11) is a digital dynamometer (11) which, even more preferably, comprises a memory that stores the patient data for each session, or, either, a transmitter that sends said data to a terminal where the data is stored.

The several harness models (12) herein suggested overcome several situations and needs of human or animal patients (2), such as: moving from and to a wheelchair, passing from a table to a surgery table, walking and standing exercises, physiotherapy in swimming-pools or the like, vestibulation exercises, progressive recovery by equines in boxes, recovery by pets such as cats and dogs, treatment of animals intended for cattle raising such as stallions and milk high-yielding cows, treatment and rehabilitation of zoo animals, etc.

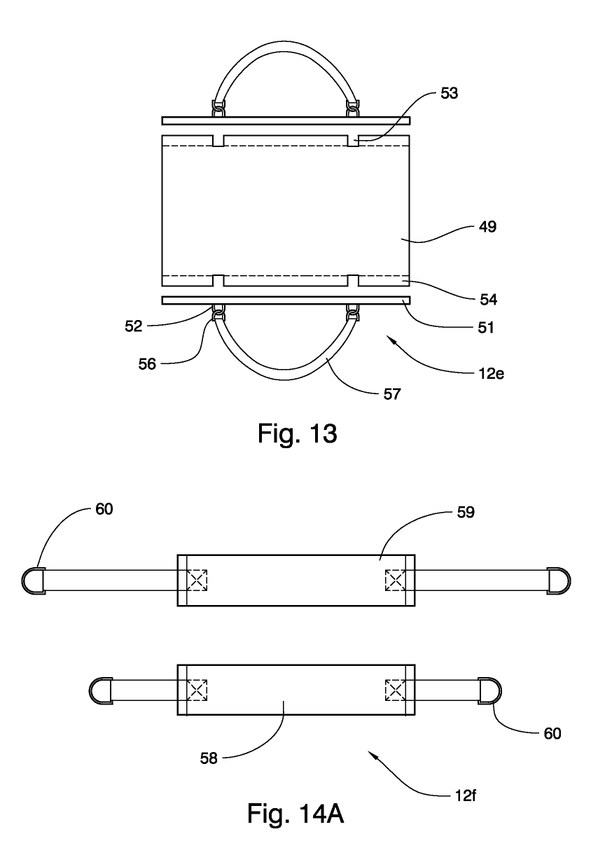

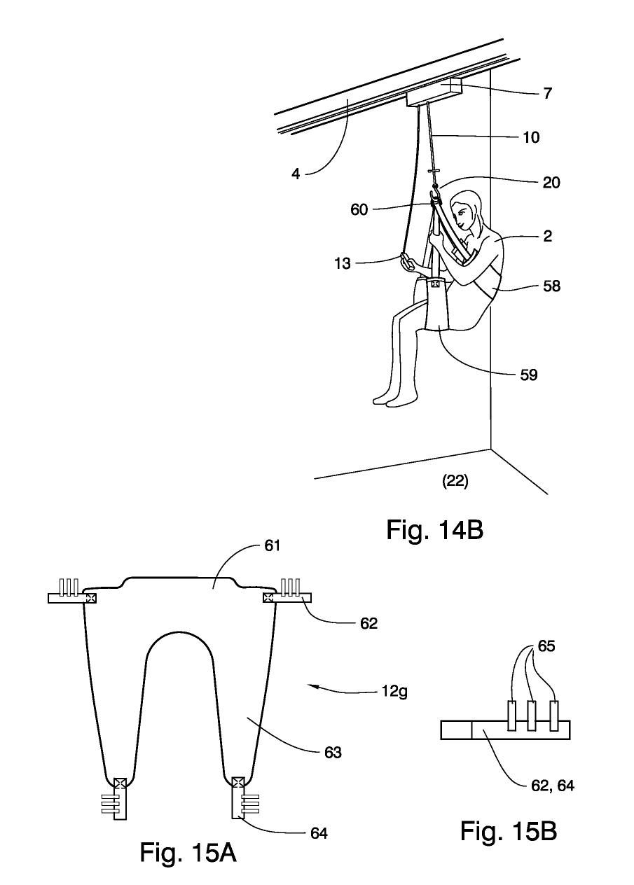

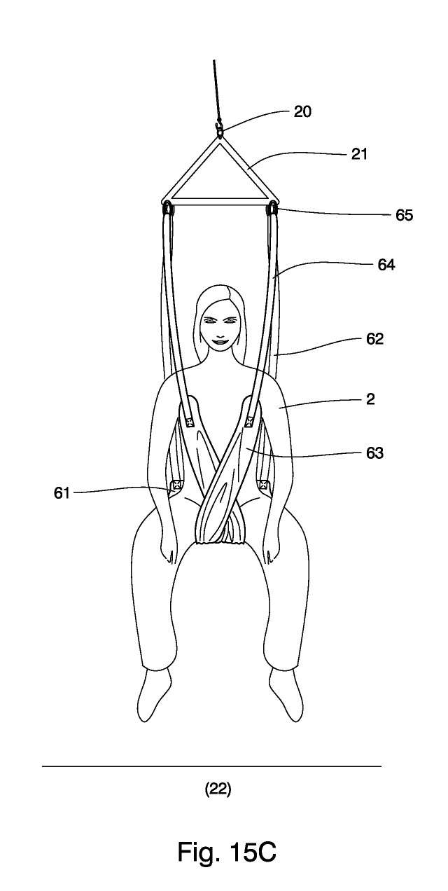

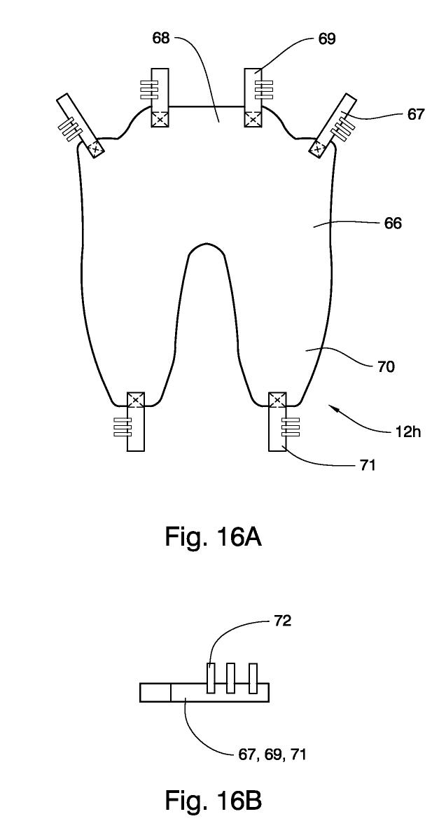

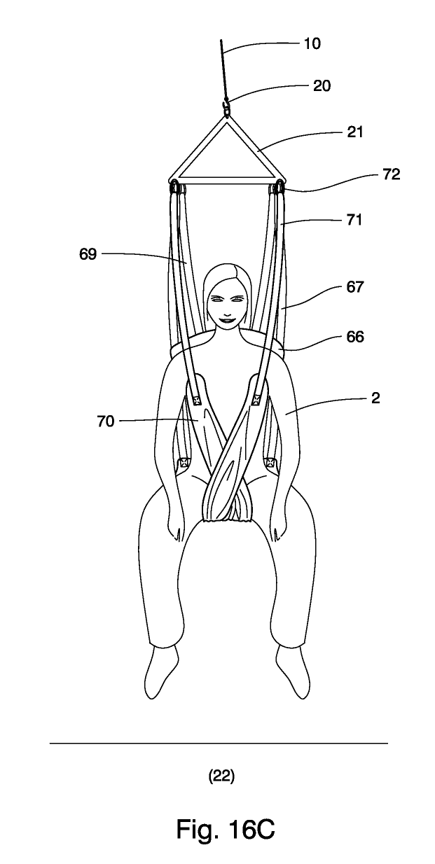

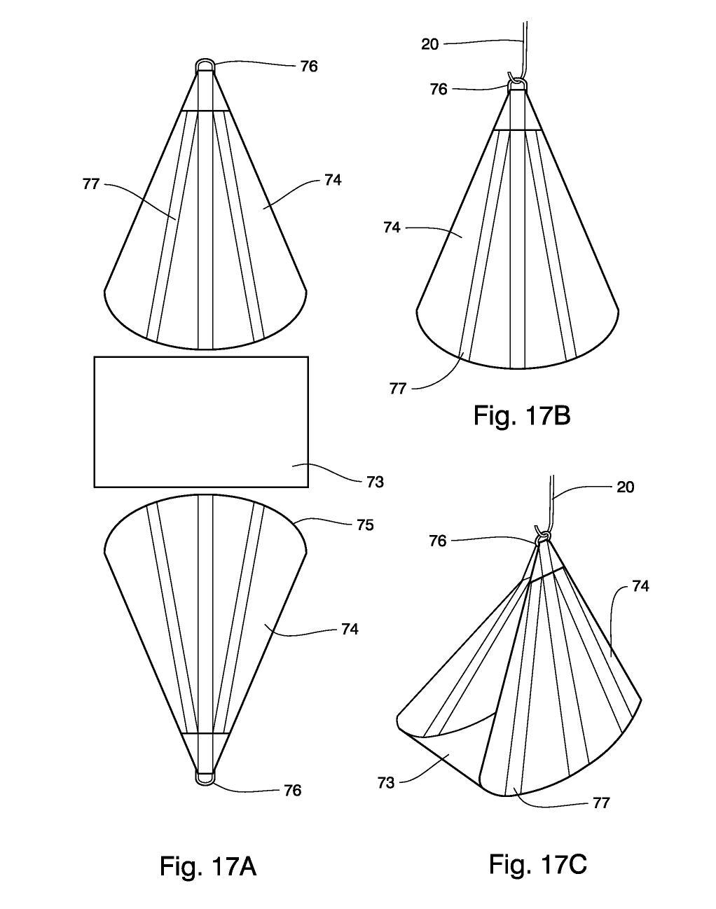

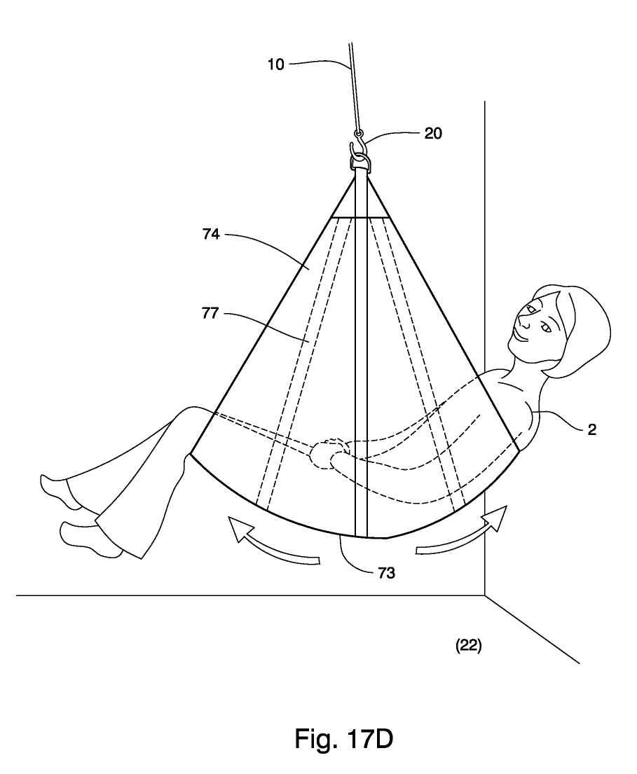

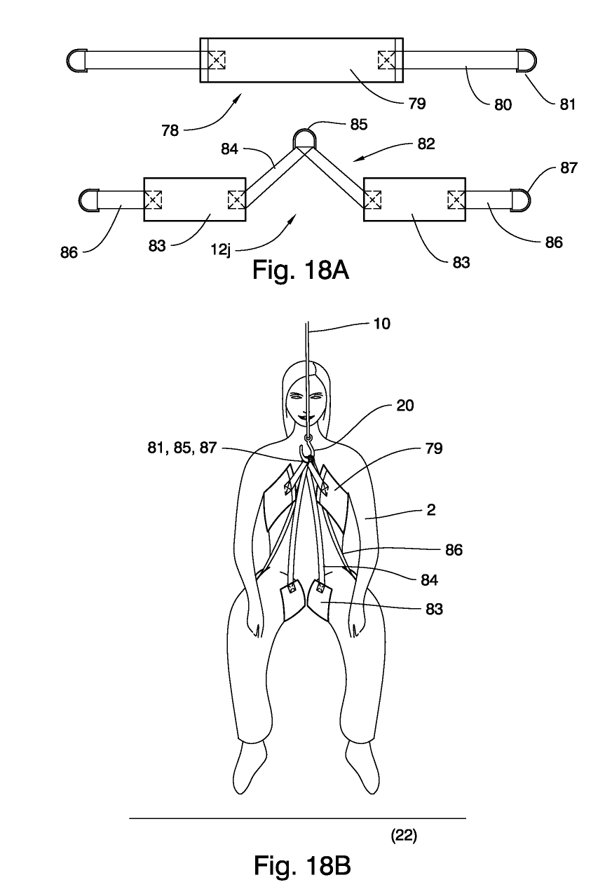

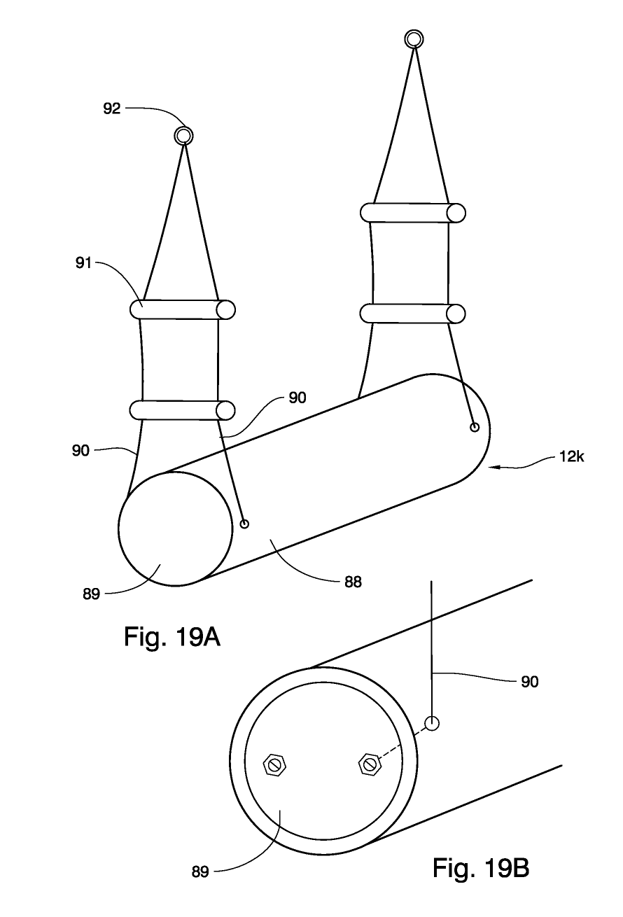

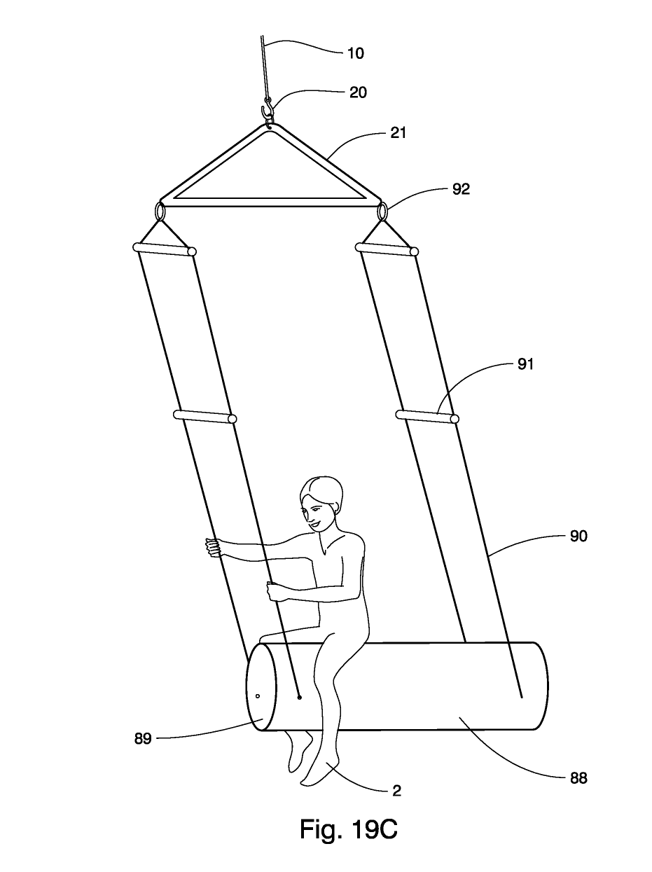

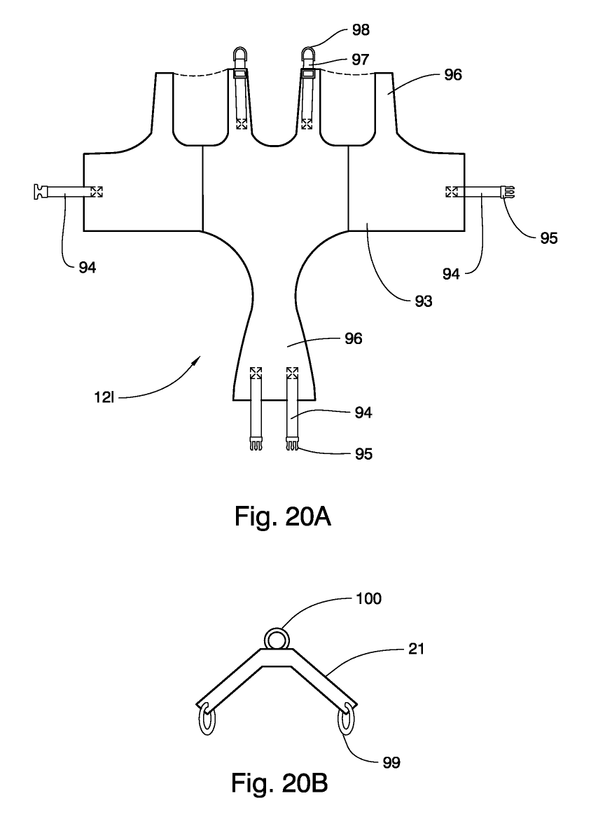

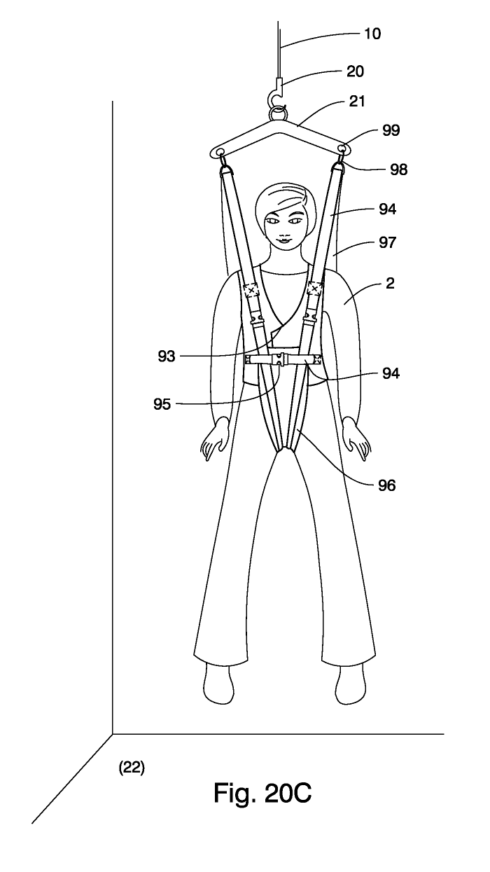

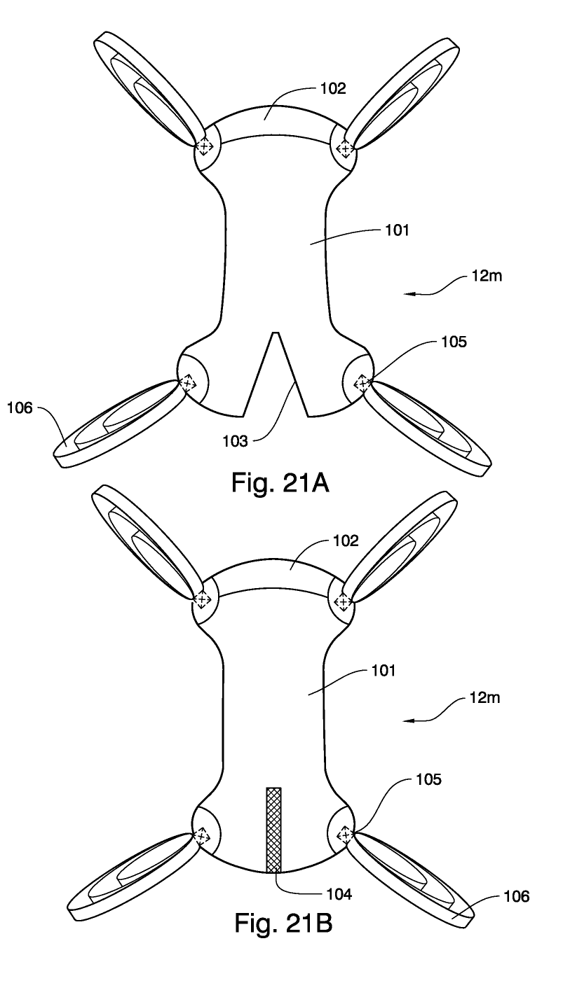

The harness (12) for treatment and rehabilitation of a human patient (2) can be selected from: harness (12a) for standing device, which fastens the legs by the groin and also fastens the trunk in order to keep the patient in an upright position (FIGS. 9A and 9B); harness (12b) for standing device with leg fasteners and trunk fasteners in order to keep the patient in an upright position (FIGS. 10A and 10B); ergonometric harness (12c) for standing device with trunk fastener (FIGS. 11A and 11B); stepping panel table (12d) (FIGS. 12A and 12B); backboard table (12e) (FIG. 13); articulated ergonometric harness (12f) (FIGS. 14A and 14B); vestibulation harness (12g) with pelvic girdle holder (FIGS. 15A and 15B); vestibulation harness (12h) with trunk holder (FIGS. 16A and 16B); vestibulator swing (12i) (FIGS. 17A, 17B, 17C and 17D); harness (12j) for equine therapy (FIGS. 18A and 18B); vestibulation bolster (12k) (FIGS. 19A, 19B and 19C); jacket-diaper harness (12l) (FIGS. 20A, 20B and 20C); and permanent transportation harness (12m) (FIGS. 21A, 21B and 21C).

The standing device harness (12a) with leg fasteners by the groin and trunk fasteners for keeping the patient in an upright position (FIGS. 9A and 9B) allows the patient (2) to remain held by the trunk in a comfortable and safe manner, thereby preventing him/her from slipping from the harness (12a) by fastening belts (29) on the groin. In a preferred form of embodiment, this harness (12a) comprises a substantially rectangular fabric panel (25) that encloses the trunk by a plurality of fastening belts (26), two lateral couplings (27) at the top with mounting parts (28) on the panel border (25) on the front and back, and two fastening belts (29) at the bottom for the groin so as to protect the crotch of the patient (2) and to prevent the patient from slipping from the trunk fastener. Lateral couplings (27) are coupled on a hanger (21) that is suspended from the supporting hook (29) linked to the lifting motor (7) by a wire (10) pulley (24).

The harness (12b) for a standing device with leg fasteners and trunk fasteners for keeping the patient in an upright position (FIGS. 10A and 10B) allows the patient (2) to be supported by the trunk in a comfortable and safe manner in order to avoid any slipping from the harness (12b) as secured by leg fasteners, while the lines of the leg fasteners cause the patient (2) to lower his legs and not to keep them bent. In a preferred form of embodiment, this harness (12b) comprises a substantially rectangular fabric panel (30) enclosing the trunk and comprising a plurality of fastening belts (31), two lateral couplings (32) at the top with mounting parts (33) on the panel border (30) on the front and back, and two pairs of lines (34), one in the front and the other behind each pair, which end in two substantially rectangular panels (35) that enclose the legs and fasten them by at least two fastening belts (36), thereby protecting the crotch of the patient (2) and preventing the patient from slipping from the trunk fastener. Lateral couplings (32) are coupled on a hanger (21) that is suspended from the supporting hook (29) linked by a wire (10) to the lifting motor (7) by a wire pulley (24)

The ergonometric harness (12c) for a standing device with trunk fasteners (FIGS. 11A and 11B) includes no leg fastener and is used in those cases where the patient (2) has had both legs amputated and must do rehabilitation with orthopedic legs. In a preferred form of embodiment, this harness (12c) comprises a substantially trapezoidal fabric panel (37) which encloses the trunk of the patient (2) and comprises a plurality of fastening belts (38) and top side couplings (39) with mounting parts (40) on the fabric panel border (37) on the front and on the back. The substantially trapezoidal shape of the fastening panel (37) when enclosing the patient's trunk (2) creates a cone which smaller opening is at the bottom so as to prevent the patient (2) from slipping from the harness (12c). Lateral or side couplings are suspended from a hanger (21) which is suspended from the supporting hook (20) linked to the lifting motor (7) by a wire pulley (24).

The stepping panel table (12d) (FIGS. 12A and 12B) comprises a side articulation or hinge (41) that allows the table (12d) to bend in a “V” pattern with the patient (2) inside, depending on the point of support. This is the ideal position for patients (2) who must undergo a spine surgery. Eventually this articulation (41) comprises a lock to keep the table (12d) rigid. In a preferred form of embodiment, this table (12d) comprises a substantially rectangular panel (42) with border hems (43) through which two bearings (44) are passed with a hinge or articulation (41) in the middle thereof, and at least two supporting rings (45) at equal distance from the ends, where said hems (43) comprise notches (46), through which said articulations (41) are accessed, and rings (45). In fact, the notches (46) in hem (43) exhibit articulations (41) to handle them and rings (45) from which couplings (47) for said handles (48) are fixed, which rings are parallel to the bearings (44) and from which the table (12d) is suspended from a supporting hook (20) linked to the lifting motor (7) by a wire (10) pulley (24).

The backboard (12e) (FIG. 13) is kept rigid with the patient (2) inside. In a preferred form of embodiment, this backboard (12e) comprises a substantially rectangular panel (49) with hems (50) on the borders through which two bearings (51) are passed, which comprise at least two supporting rings (52) at equal distance from the ends. The panel (49) comprises grooves (53) on the hem (54) to expose the rings (55) from which handle (57) couplings (56) are fixed, which handles are disposed parallel to the bearings (51) and from which a table (12e) is suspended from a supporting hook (20) linked to the lifting motor (7) by a wire (10) pulley (24).

The articulated ergonometric harness (12f) (FIGS. 14A and 14B) is useful for transferring a disabled patient (2) from a bed or table to a wheelchair and vice versa. In a preferred form of embodiment, the articulated ergonometric harness (12f) comprises two substantially rectangular independent panels (58, 59) of about the same surface, on which ends the line ends are fixed on supporting rings. Both parts of the harness (12f), once the shortest one (58) is passed on the back and the longest one (59) is passed below the patient's legs, are suspended by the rings (60) from a supporting hook (20) linked to the lifting motor (7) by a wire (10) pulley (24).

The vestibulation harness (12g) for holding the pelvic girdle (FIGS. 15A, 15B and 15C) is employed for vestibulation exercises when the patient (2) is held by the trunk, i.e., he/she controls the torso muscles. In a preferred form of embodiment, this harness (12g) comprises a panel (61) with a substantially rectangular base extending to the longitudinally opposite ends of each of its sides with at least two lines (62), where said side projects beyond the limit defined by the lines (62), and which extends beyond the side opposite to the former one and projects two substantially triangular panels (63) that end in at least one line (64) each. Each line (62, 64) ends in a plurality of supporting rings (65) that allow selecting the best manner for fixing the harness (12g)/patient (2) assembly. The patient (2) is sitting on the base panel (61) that supports or holds him by the pelvic girdle and the two substantially triangular panels (63) are crossed in the front through the groin (63). For hoisting the assembly, the harness (12g) is suspended with the patient (2) by the supporting rings (65) on a hanger (21) suspended from a supporting hook linked to the lifting motor (7) by a wire (10) pulley (24).

The vestibulation harness (12h) that holds the trunk (FIGS. 16A, 16B and 16C) is used for vestibulation exercises when the patient (2) is not held by the trunk, i.e. the patient has no control of torso muscles. In a preferred form of embodiment, this harness (12h) comprises a substantially rectangular base panel (66) that extends through the longitudinally opposed ends of each of the sides thereof with at least two lines (67), while a panel extension (68) projects from said side, from which ends other two lines (69) project, so that between said end lines (67, 69) taken in pairs a path is generated for the arms of the patient (2). Likewise, the harness (12h) extends from the side opposite to the former one and projects two substantially triangular panels (70) that end in at least one line (71) each. Each line (67, 69, 71) ends in a plurality of supporting rings (72) that allow selecting the best manner for fixing the harness (12h/patient (2) assembly. The patient (2) is sitting on the base panel (66) that holds him by the trunk and the pelvic girdle and the substantially triangular two panels (70) are passed in the front across the crotch. In order to hoist the assembly, the harness (12h) with the patient (2) is suspended by the supporting rings (72) on a hanger (21) on a supporting hook (20) linked to the lifting motor (7) by a wire (10) pulley (24).

The vestibulator swing (12i) (FIGS. 17A, 17B, 17C and 17D) allows a patient (2) to be hoisted therein and, for example, to be swung for vestibulation exercises. In a preferred form of embodiment, this harness (12i) in a swing shape comprises a substantially rectangular bottom or base (73) being a recessed surface supported by two substantially triangular sides (74) which lower base (75), through which said sides are linked to the bottom (73) is curved and fixed at the top to corresponding rings (76) in order to hang the assembly. Substantially triangular sides (74) comprise radially disposed reinforcing straps (77). The rings (76) for suspending the assembly are hung on a single supporting hook (20) linked to the lifting motor (7) by a wire (10) pulley (24).

The equine therapy harness (12j) (FIGS. 18A and 18B) allows patients with motor disabilities to get on equines. In a preferred form of embodiment, the equine therapy harness (12j) comprises two portions: a top portion (78) formed by a substantially rectangular panel (79) at which ends lines (80) are fixed and end in supporting rings (81), and a lower portion (82) rectangular panels (83) linked to each other by a single line (84) fixed in a “V” shape, and on which vertex there is a ring (85) and corresponding lines (86) fixed on the remaining ends of the panels (83) which are also attached to a ring (87). Both portions (78, 82) of the harness (12j), once the upper panel (79) is passed at the back and each panel (83) of the lower portion is passed behind the legs of the patient (2), are suspended by means of the rings (81, 85, 87) in a uniform manner at the level of the chest of the patient (2) from a supporting hook (20) linked to the lifting motor (7) by a wire (10) pulley (24). When hoisted, the patient (2) is in a sitting position in the air and with legs in an open position, thereby allowing the patient to be placed on a horse so as to continue with the equine therapy session.

The bolster (12k) (FIGS. 19A, 19B and 19C) is employed for human patients who need a rehabilitation treatment for vestibular-related balance disorders. In a preferred form of embodiment, the vestibulation bolster (12k) consists in a cushioned cylinder (88) with hard covers (89) at the ends, where two lines (90) are fixed and have a side exit on each end of the bolster (12k), said lines being joined on their upward trajectory by at least two transversal handles (91) and concurring on a single hanger (92) on each end. The ends of the bolster (12k) are substantially round covers (89) on which the ends of lines (90) are internally fixed in order to be directed to the sides from where they exit the said bolster (12k). The bolster (12k) is suspended from said rings (92) by means of a hanger (21) ad hoc for use in vestibulation exercises, said hanger being held by a supporting hook (20) linked to the lifting motor (7) by a wire (10) pulley (24).

The jacket-diaper harness (12l) (FIG. 20A, 20B and 20C) is useful for holding a patient (2) by his/her crotch while the patient is held by the torso at the same time. In a preferred form of embodiment, the harness (12l) comprises a jacket (93) that encloses the thorax and is closed on the front by two lines (94) that end in both closing hooks (95), while a lower projection (96) of the jacket (93) goes down on the back of the patient (2) and is attached to the jacket (93) on the front by at least two lines (94) with corresponding closing hooks (95). Straps (96) of the jacket (93) comprise lines (97) that end in the rings (98) for fixing to the grabs (99) of a hanger (21) to that effect, which is supported by a central ring (100) by a supporting hook (20) linked to the lifting motor (7) by a wire (10) pulley (24).

The permanent transportation harness (12m) (FIG. 21A, 21B and 21C) is useful for those patients (2) who are not able move by themselves. In a preferred form of embodiment, the permanent transportation harness (12m) comprises a substantially rectangular panel (101) with rounded ends, where at least one of the ends includes reinforcement (102) and the other a longitudinal cut (103) that once sewed forms a closing (104) that creates a recess holding the patient. From each vertex of the harness (12m) there project lines (105) that end in a plurality of rings (106) from which a harness (12m) is suspended by a supporting hook (20) linked to the lifting motor (7) by a wire (10) pulley (24).

Preferably, the above described harnesses (12) for use with patients of less than about 90 kg by weight can be manufactured with hypoallergenic vinyl canvas, neoprene or the like, and the lines are preferably made of nylon fabric or the like. Preferably, the above harnesses (12) for use with patients of more than about 90 kg by weight are made of hypoallergenic vinyl canvas and the lines are preferably made of nylon fabric or the like.

Therapy tables used for patients with burns are preferably made of hypoallergenic vinyl canvas and hydrating or moisturizing gel, which replaces the plasma, as this material can be sterilized by moist heat.

In the veterinary field, a harness (12n) for quadruplet animals is provided, preferable for equines, which bears the weight of the animal (2) and distributes such weight among several supporting points. In a preferred form of embodiment, the harness for equines (12n) comprises several portions: a ventral supporting assembly 107, which is substantially rectangular and is formed by a plurality of layers of different types and materials, between said layers there being at least two independent inflatable receptacles (108) with multiple cavities (109) mutually linked to two interconnecting conduits (110) extending longitudinally, where said cavities (109) are transversally and parallel disposed in an alternate pattern covering the entire surface of the supporting assembly (107).

Preferably, the plurality of layers of the vental supporting assembly (107) comprise, from the inner to the outer layer: a first fabric layer (111), basically made of a canvas-type cotton or Denim (jean), which is in contact with the skin of the animal; a second layer (112) made of felt, preferably of wool fibers; a third layer (113) formed by a polyurethane rubber foam; a fourth layer (114) formed by at least two independent inflatable receptacles (108) with multiple mutually related cavities (109), said receptacle being made of a gas-proof fabric or film; a fifth layer (115) formed by polyurethane foam rubber; a sixth layer (116) formed by felt, preferable made of wool fibers; a seventh layer (117) basically made of cotton fabric, of a canvas or denim/jean kind; and an eighth layer (118) formed by a wound fabric with alternate intercrossed lines (119) where a plurality of lines (120) project laterally, which end in the supporting rings (121), said lines (119, 120) being preferably of a nylon or like fabric. The different layers (111, 112, 113, 114, 115, 116, 117, 118) are sewed one to the other as a whole assembly.

The plurality of side lines (120) that end in corresponding supporting rings (121) of said ventral supporting assembly (107) are useful in fixing the harness (12n) to the supporting points of a hanger or supporting frame or structure (122).

Likewise, and additionally, the harness (12n) comprises four substantially conical sleeves (123) for holding the forearms and highs of the equine (2), each crossing at least two lines (124) that end in corresponding supporting rings (125), which are sewed for fixing the sleeves (123) to the supporting frame (122).

Preferably, the sleeves (123) are made of rubber fabric and polyurethane, where this latter material provides an efficient cushion pattern for the animal while in use. On the other hand, lines (124) are made of nylon fabric.

The supporting frame (122) is formed by a series of bearings (126) and beams (127) that constitute the corners and vertexes of a regular prism with substantially rectangular base and sides and which front and back faces are substantially triangular, where longitudinal bearings (126) comprise a plurality of supporting grommets (128) for attaching the supporting rings (121125) to the ventral supporting assembly (107) and sleeves (123), and, above, at least one supporting grommet (129) for hanging the assembly from a supporting hook (20) linked to the lifting motor (7) by a wire (10) pulley (24).

The multiple cavities (109) of the inflatable receptacles (108) are filled with compressed air by at least one compressor (130), where air may be filled in an independent and alternate manner by valves (131) that allow the entrance and exit of air in a predetermined manner, thereby increasing or reducing the pressure of each inflatable receptacle (108) to achieve an alternate and efficient massage on the belly and sides of the animal patient (2).

Preferably, the compressor (130) has a compressing capacity of 75 to 110 pounds/square inch and compresses air continuously on the valves (131) which alternatively release a pressure of about 14/pounds/square inch every 3 to 5 or 10 minutes. Each valve (131) prevents the air release and allows the air inlet to recover the pressure by starting a new cycle. Thus, when one of the inflatable receptacles (108) is inflated, the other is decompressed and vice versa on a continuous pattern and provides the animal (2) with a massage on its ventral area.

Also preferably, the inflatable receptacles (108) are made of a resistant and air-retaining material selected from waterproof nylon fabric and a polyvinyl film, such as Panaflex or the like.

Whenever necessary or useful, a dynamometer (11) is installed between the hook (10) at the end of the wire (10) of the standing device (1) and the harness (12) in order to control the weight borne by the limbs of the human or animal patient (2).

### Mode of Operation

Once the human patient has been provided with the harness suitable to his/her physical condition, the harness is then attached to the end of the preferably steel wire of an intermediate hanger

Then, the whole assembly together with the human or animal patient makes up a single unit, which is ready to start with the rehabilitation exercises.

The operator assisting the human or animal patient operates the remote control so that the human or animal patient can be lifted and transported with no effort to the point of the room where the activity is to be performed.

As the case may be, the operator will apply a particular load on the limbs of the human or animal patient by a simple process which comprises softly and slowly releasing the wire, centimeter by centimeter, until the dynamometer indicates that the desired load has been reached. For example, if the human or animal patient weighs 70 kg, when the dynamometer indicates 50 kg, the patient will be bearing a load of 20 kg on his legs.

At any time, the human or animal patient will be able to move by his/its own means if possible on account of his/its condition, or by the assistance of the operator, without falling or stumbling, since the harness is firmly secured to the whole structure.

When human or animal patients under rehabilitation move between two points within the area covered by the device, namely, from one end to the other of the fixed parallel rails and from one end to the other of the possible track of the movable parallel rails, the device will work as a suspended movable standing device.

However, this device mainly allows diverse and highly valuable applications for accelerating the rehabilitation process in human or animal patients, and such applications are not limited to those intended for lifting or laying human or animal patients or facilitating limb rehabilitation with a controlled load.

The kind of human or animal patients particularly benefited from this invention are those affected by lower-limbs motor disorders caused by neurological, orthopedic or rheumatic conditions.

The neurological disorders treated with this device comprise all those resulting in difficulties to make translational movements, either by the patient himself or by caretakers, or to stand, as in the case of paraplegia or paraparesis.

Orthopedic disorders comprise those exhibited by human or animal patients who have suffered any kind of traumatism temporarily preventing their motor activities. In this case, it is helpful for them to perform rehabilitation activities within or outside other spaces of common assistance, as in the case of parallel bars.

According to this present invention, the human or animal patient exceeds the restricted scope of activities defined by parallel bars. In fact, they are not necessary at all, since the suspension standing device allows the human or animal patient to move in different directions without the support of the bars.

Using the digital dynamometer will allow the performance of exercises on lower limbs, exercises involving weight transfer and positional exercises, without any excessive partial and progressive load as necessary, since said load can be then determined precisely.

Likewise, and according to this invention, rehabilitation processes are shorter in time, since the previous strengthening of upper limbs for parallel bars or crutches will be no longer necessary.

The human or animal patient under rehabilitation will be also able to perform exercises in a vertical position well before and more effectively than in a quasivertical position, this latter position being usually the only one applying partial load on limbs in the absence of an invention like the one herein described.

This device ensures that the human or animal patient under treatment will not fall down at any moment while performing the rehabilitation/recovery activities, thereby allowing an otherwise impossible standing position, i.e., allowing an individual to exercise without the continuous and constant assistance by third persons.

It is important to note that the controlled-suspension standing device according to the present invention allows neurological human and animal patients to enjoy a full and natural vertical and standing position as compared with any other prior device. This is mainly achieved because the standing device of the present invention is of a “suspended” kind.

This present invention provides a fully innovating and overcoming solution for kinesiology treatments aimed at the rehabilitation of humans or animals with difficulties or complete inabilities to walk and/or stand, and the inventive device can be used both on hard surfaces and in swimming-pools, it being also possible to precisely control the working load applied on the lower limbs of the human or animal patient under treatment.

Likewise, the different vestibulation harnesses and the vestibulator cone are precisely used for vestibulation exercises. By these exercises the patient is intended to recover the balance lost as a result of any inner ear disorder caused by a viral infection, cranial traumatism or Menière disease.

Since the inner ear is responsible for the sense of balance and positioning in space, when the same is affected by any disorder the symptoms normally appearing as a result include dizziness, nausea, vomiting and instability. This disorder can be treated by means of specific exercises until a total recovery is achieved. In fact, the device of the present invention provides the treatment for this disorder.

Within a strictly veterinary field, any animal suffering from post-traumatic or post-surgical recovery processes which require to keep the animal standing and controlled, or which require any assistance while standing, can be supplied with a harness ad hoc and suspended from the device according to the present invention until the animal is fully recovered, while calibrating the load exerted on the animal limbs.

For example, the use of this inventive device on equines is to be noted, since the device operates in a manner similar to that used on humans and not only allows keeping the animal in an upright position but also enables the animal to move in any direction within the surface covered by the apparatus.

The invention can be used for recovery after anesthesia, surgery—when surgery is conducted on one side-, short or long-term care of horses or any other quadruplet animal with difficulties for standing or which must bear reduced weight on their limbs, as well as in the case of horses or any other quadruplet animal with neurological problems, among the most outstanding cases.

This kind of support, apart from being more comfortable and safer, dramatically reduces the risk of injuries and violent reactions derived from handling of the animal. On the other hand, as this device allows transportation of the animal, the recovery process is thus facilitated because the animal does not need to remain in a resting position when affected by injuries on its limbs or by any other disease that may prevent it from moving to drink and eat.

When horses and any other quadruplet animal remain in a lying position for a long time, they suffer severe health complications, such as lung congestion, micitis and scars, which in some cases may lead to death of the animal. For that reason, a device that enables said animals to remain standing and to walk, when they will be otherwise lying, proves to be highly useful.

Typical uses of the device include those for horses with neurological disorders or with any of their limbs broken, which require limiting the weigh load to be borne by said limbs during the recovery process. The animal can then remain standby until, while recovering, the weight to be borne by its limbs is regulated and the animal manages to move in any direction within the room or place of location.

For the case of fractures or any kind of limb problems, the animal normally reacts by passing part of its weight to the healthy limbs, which are then required to make an excessive effort that will subsequently lead to an even greater problem.

Another relevant use of this invention comprises ensuring the flotation of the horse or any other quadruplet animal in a swimming pool. Horses may be frequently drown while training in swimming-pools, because, once they start to sink, it is practically impossible to make them float.

The device according to this present invention significantly improves the quality of life of these animals by relieving them from the pain produced by their own weight on the affected body portions but, in addition, it enables them to move on the floor plane and to thereby walk while bearing little weight, which is helpful during the rehabilitation process.

The main advantage of the inventive standing device as compared with prior art devices is that it comprises a “suspended” device, i.e., the human or animal patient can be hung or suspended from an supporting means placed overhead, which allows the free and full movement of all lower limbs of the patient.

The foregoing discloses the high versatility of the device of the present invention which is not found in any other prior art device.

1. A standing device for human or animal patients that need treatment and/or rehabilitation, CHARACTERIZED by comprising: two fixed parallel rails on which two movable parallel rails are movably and freely linked thereto by wheels in a forward-backward direction (axis y) and perpendicular to the former ones, and a base structure on the assembly of movable parallel rails which is movably are freely linked thereto by wheels in a right-left direction (axis x), said base structure comprising an electric motor operated by remote control and from which end a cable is suspended to which a harness is attached according to the physical and medical characteristics of the human or animal under treatment.

2. The standing device according to claim 1, CHARACTERIZED in that the base structure movably linked by wheels on the assembly of movable parallel rails allows the left-to-right movement (axis x) to be transmitted to the assembly consisting of motor, wire, hook, an eventual intermediate hanger, harness and a human or animal patient under treatment, along the movable parallel rails.

3. The standing device according to claim 1, CHARACTERIZED in that the dynamometer sequentially disposed between the motor and the human or animal patient under treatment measures the load applied thereon at any time.

4. A standing device which facilitates the combined three-dimensional movement as desired, by allowing a free left to right or vice versa movement and the forward to backward or vice versa movement and a upward to downward or vice versa controlled movement by human or animal patients with motor disabilities caused by neurological, orthopedic or rheumatic disorders, and which device is intended for treatment of and/or recovery from said disorders, said device being CHARACTERIZED by comprising:
a pair of parallel fixed rails;
a pair of parallel movable rails mounted by means of wheels on parallel fixed rails; and
an electric motor mounted on a movable base structure which is supported by wheels on movable parallel rails and which shaft is linked to a wire from which a dynamometer and a harness are suspended, said electric motor being remotely operated.

5. The standing device according to claim 4, CHARACTERIZED in that the two fixed rails are parallel installed at both ends of the room and in a direction coinciding with the “forward-backward” movement.

6. The standing device according to claim 4, CHARACTERIZED in that the fixed rails and the movable parallel rails are grooved in order to facilitate the transit of several wheel assemblies within the grooves and throughout its length.

7. The standing device according to claim 5, CHARACTERIZED in that the fixed parallel rails are installed in the room by means of a plurality of perpendicular mounting parts that link the ceiling to said rails.

8. The standing device according to claim 4, CHARACTERIZED in that the two movable rails are parallel mounted and linked by at least two rigid metal pieces in order to secure such parallel pattern, where the metal rigid pieces fix the ends of said movable rails.

9. The standing device according to claim 8, CHARACTERIZED in that said rigid metal pieces comprise a beam linked to two couplings at its ends and which are fixed to the ends of each of the movable rail, thereby forming an assembly of movable rails, and both rigid pieces substantially form a rectangle.

10. The standing device according to claim 8 or 9, CHARACTERIZED in that the movable rails are linked to the rigid pieces by attachment means selected from the group consisting of coupling and welding, coupling and screws, coupling and pins, and combinations thereof.

11. The standing device according to claim 4, CHARACTERIZED in that the movable rails intercept the fixed rails at a 90° angle.

12. The standing device according to claim 4, CHARACTERIZED in that a plurality of wheels is installed at both ends of each of the movable rails, which wheels supply movement to the movable rails along the whole track allowed by the fixed parallel rails, where the wheel assemblies are fixed to the ends of the rigid pieces that keep the movable rails parallel.

13. The standing device according to claim 4, CHARACTERIZED in that a plurality of wheels is installed at the end portions of the base structure of the electric motor in order to allow movement thereof along the track of the grooves of movable rails.

14. The standing device according to claim 4, CHARACTERIZED in that the base structure of the electric motor consists in a painted plate structure having substantially the shape of a casing, is mounted below the movable parallel rails and is linked thereto by wheel assemblies that allow the movement of the assembly formed by the motor base structure, electric motor, motor remote control, wire with a hook at its end, eventual intermediate supporting hanger, harness and human or animal patient along the track of the grooves of the movable rails.

15. The standing device according to claim 14, CHARACTERIZED in that the wire is a steel wire.

16. The standing device according to claim 14, CHARACTERIZED in that the electric motor is mounted within the casing that forms the base structure of the electric motor.

17. The standing device according to claim 16, CHARACTERIZED in that the electric motor is operated by a remote control for controlling the upward and downward movement of a wire, to which a hanger is linked by a hook and from which hanger and harness are suspended, or directly a harness without intermediate hanger is suspended.

18. The standing device according to claim 17, CHARACTERIZED in that the dynamometer is between the wire hook and the intermediate hanger or the harness.

19. The standing device according to claim 17, CHARACTERIZED in that the operation at a distance is a remote control.

20. The standing device according to claim 17, CHARACTERIZED in that the speed control of the electric motor comprises a mechanic speed reducer, an electronic speed reducer, or a combination thereof.

21. The standing device according to claim 17, CHARACTERIZED in that the motor is fed by a single-phase voltage of 110 Volt or 220 Volt.

22. The standing device according to claim 17, CHARACTERIZED in that the remote control has an applied voltage of 12 Volt obtained by reducing the single-phase voltage of 110 Volt or 220 Volt.

23. The standing device according to claim 17, CHARACTERIZED in that the end of the motor shaft or of the mechanic speed reducer comprises a pulley through which the wire is passed.

24. The standing device according to claim 18, CHARACTERIZED in that the dynamometer is a digital dynamometer.

25. The standing device according to claim 24, CHARACTERIZED in that the dynamometer comprises a memory that stores the data of the patient for each session or a transmitter that sends the data to a terminal where said data is stored.

26. The standing device according to claim 4, CHARACTERIZED in that the harness for a human patient is selected from a group consisting of: a harness for a standing device which fastens the legs by the groin and fastens the trunk in order to keep the patient in an upright position, a harness for a standing device with leg fasteners and trunk fasteners to keep the patient in an upright position, an ergonometric standing device with trunk fasteners, a stepping panel table, a fixed panel table, an articulated ergonometric harness, a vestibulation harness with pelvic girdle holder, a vestibulation harness with trunk holder, a vestibulator swing, an equine therapy harness, a vestibulation bolster, a jacket-diaper harness, a permanent transportation harness.

27. The standing device according to claim 26, CHARACTERIZED in that the standing device harness with leg fasteners by the groin and trunk fasteners for keeping the body in an upright position, which comprises a substantially rectangular panel that encloses the trunk of the human patient with a plurality of fastening belts, comprises two top side couplings or hooks with attachments or mounting parts on the front and back border of the panel, and two groin fastening belts below covering the crotch, where the side couplings are coupled to an intermediate hanger that is suspended from the supporting hook linked to the lifting motor by a wire pulley

28. The standing device according to claim 26, CHARACTERIZED in that the standing device harness with leg fasteners and trunk fasteners in order to keep the body in an upright position comprises a substantially rectangular panel that encloses the patient's trunk and comprises a plurality of fastening belts, two top side couplings with mounting parts on the front and back border of the panel, and two lower pair of lines, one in the front and the other at the back of each pair, which end in two substantially rectangular panels that enclose the patient's legs and fasten them by at least two fastening belts that cover the groin and prevent slipping from the trunk fasteners, where side couplings are coupled on a hanger that is suspended from the supporting hook linked to the lifting motor by a wire pulley.

29. The standing device according to claim 26, CHARACTERIZED in that the standing device ergonometric harness with trunk fasteners comprises a substantially trapezoid panel that encloses the patient's trunk and creates a substantial cone, where the panel comprises a plurality of fastening belts, two top side couplings with mounting parts on the front and back panel border, where side couplings are suspended on a hanger from the supporting hook linked to the lifting motor by a wire pulley

30. The standing device according to claim 26, CHARACTERIZED in that the harness is a stepping panel table comprising a substantially rectangular panel with hems on the borders through which two beams are passed with a hinge in the middle and at least two supporting rings at equal distance from the ends, where said hems comprise notches that lead to said hinges and rings from which handle couplings are attached, said handles being parallel to beams and hold a table suspended from a hook linked to the lifting motor by a wire pulley.

31. The standing device according to claim 26, CHARACTERIZED in that the harness is a backboard table comprising a substantially rectangular panel with border hems through which two beams are passed which comprise at least two supporting rings at a same distance from the ends, where said hems comprise notches that exhibit the rings from which handle couplings are attached parallel to the beams and from which a table is suspended from a supporting hook linked to the lifting motor by a wire pulley.

32. The standing device according to claim 26, CHARACTERIZED in that the ergonometric articulated harness comprises two substantially rectangular independent panels of about the same surface, on which ends the line ends are fixed at the supporting rings, where both panels enclose the patient and are hung by the rings from a supporting hook linked to the lifting motor by a wire pulley.

33. The standing device according to claim 26, CHARACTERIZED in that the vestibulation harness that holds the pelvic girdle comprises a substantially rectangular base panel which extends through longitudinally opposite ends of one of its sides with at least two lines, where said side is projected beyond the line formed by the lines and extends from the side opposite to the former one and projects two substantially triangular panels which end in at least one line each, where each line ends in a plurality of supporting rings which allow selecting the best attachment or fastening means for the harness/patient assembly, and where the patient is sitting on the base panel supporting him/her by the pelvic girdle and the two substantially triangular panels are crossed on the front and through the groin for lifting the harness/patient assembly, the harness and the patient being suspended by the holding rings on a hanger suspended from the supporting hook linked to the lifting motor by a wire pulley.

34. The standing device according to claim 26, CHARACTERIZED in that the vestibulation harness with trunk fasteners comprises a substantially rectangular base panel which extends through the longitudinally opposed ends of one of the sides thereof with at least two lines, while said side extends along the panel from which two lines are projected, so that between said end lines taken in pairs a passage for the patient's arms is created which projects from the side opposite the former one and projects two substantially triangular panels which end in at least one line each, where each line ends in a plurality of holding rings which allow selecting the best manner of fastening the harness/patient assembly, and where the patient is sitting on the base panel that holds the patient by his/her chest and pelvic girdle, and the substantially triangular two panels are crossed on the front thorough the groin for lifting the harness/patient assembly, the harness being suspended together with the patient by the holding rings on a hanger that is suspended from the supporting hook linked to the lifting motor by a wire pulley.

35. The standing device according to claim 26, CHARACTERIZED in that the swing-type harness comprises a substantially rectangular bottom base which forms a recessed surface supported by two substantially triangular sides which lower base, through which they are linked to said bottom, is curved and end above in corresponding rings for hanging the assembly, where the substantially triangular sides comprise radially disposed reinforcing strands, and where the rings for hanging the assembly are suspended from a single supporting hook linked to the lifting motor by a wire pulley.

36. The standing device according to claim 26, CHARACTERIZED in that the equine therapy harness comprises two portions: a top portion formed by a substantially rectangular panel at which ends lines are attached which end in supporting rings, and a lower portion comprising two substantially rectangular equivalent panels linked to each other by a “V” shaped-attached single line, on which corner there is a ring and corresponding lines fixed to the remaining ends of the panels which also end in a ring, where both harness portions, once the top panel is passed on the back of the patient and each lower portion panel is passed behind the patient's legs, are suspended by the rings on a uniform pattern and at the level of the patient's chest from a holding or supporting hook linked to the lifting motor by a wire pulley.

37. The standing device according to claim 26, CHARACTERIZED in that the harness is a vestibulator bolster comprising a cushioned cylinder with hard covers at the ends where two side outlet lines are fixed on each end of the bolster which become unified on their upward track by at least two transversal grips or handles and concur in a single ring for each end, where the bolster ends are substantially round covers where line ends are internally fixed to be directed to the sides from which they come out of said bolster, and where the bolster is suspended from said rings by a hanger ad hoc for use in vestibulation exercises, which hanger is supported by a hook linked to the lifting motor by a wire pulley.

38. The standing device according to claim 26, CHARACTERIZED in that the jacket-diaper harness comprises a jacket that encloses the patient thorax and is closed on the front by two lines that end in corresponding closing hooks, while a lower projection of the jacket goes down behind the patient and is fixed to the front of said jacket by at least two lines with corresponding closing hooks, where the jacket straps comprise lines ending in the rings to be fixed to the hanger fasteners, which are held by a central ring by means of a supporting hook linked to the lifting motor by a wire pulley.

39. The standing device according to claim 26, CHARACTERIZED in that the permanent transportation harness comprises a substantially rectangular panel with rounded ends, wherein at least one of said ends has a reinforcing means and the other includes a longitudinal cut which, once sewed, constitutes a closure which creates a recessed patient holder, and where lines extend from each harness vertex, which lines end in a plurality of rings from which the harness is suspended by a supporting hook linked to the lifting motor by a wire pulley.

40. The standing device according to claims 26 to 39, CHARACTERIZED in that the harnesses are manufactured with hypoallergenic vinyl canvas or neoprene and the lines are made of nylon fabric.

41. The standing device according to claim 4, CHARACTERIZED in that the harness for a quadruplet animal patient comprises several points of support for the animal weight, which distribute said weight and comprise several portions: a substantially rectangular ventral supporting assembly consisting in a plurality of layers of different kind and materials, there being at least two independent inflatable receptacles between them with multiple cavities reciprocally related to two longitudinally extending and interconnecting conduits, where said cavities are transversally and parallel disposed in an alternate pattern and cover the entire surface of the supporting assembly, where said cavities and conduits retain the air.

42. The standing device according to claim 41, CHARACTERIZED in that the plurality of layers of the ventral supporting assembly of the harness for a quadruped animal patient comprise, from the inner layer in contact with the animal patient towards the outer surface: a first basically-cotton fabric layer, of a canvas or denim/jean kind; a second layer made of felt, preferably made of wool fibers; a third layer formed by polyurethane foam rubber; a fourth layer formed by an assembly of at least two independent inflatable receptacles with multiple cavities linked to each other, constituted by a gas-proof film or fabric; a fifth layer formed by polyurethane foam rubber; a sixth layer formed by felt, preferably made of wool fibers; a seventh layer of basically wool fabric, of a canvas or denim/jean kind; and an eighth layer formed by a wound fabric with alternate intercrossed lines where a plurality of lines project and end in the supporting rings, said lines being preferably of a nylon or like fabric, and where the different layers are sewed one to the other as a whole assembly.

43. The standing device according to claim 42, CHARACTERIZED in that the plurality of side lines ending in corresponding supporting rings of said ventral supporting assembly is fixed to the bearings of a supporting frame.

44. The standing device according to claim 41, CHARACTERIZED in that, additionally, the harness for a quadruplet animal patient comprises four substantially conical sleeves for supporting forearms and thighs of the animal patient, each sleeve comprising at least two lines ending in the corresponding supporting rings for fixing the sleeves to the supporting frame.

45. The standing device according to claim 44, CHARACTERIZED in that the sleeves are made of rubber fabric and polyurethane, and the lines are made of knitted nylon.

46. The standing device according to claim 43, CHARACTERIZED in that the supporting frame is formed by a series of beams and bearings constituting the corners and vertex of a regular prism having substantially rectangular base and walls and which front and rear faces are substantially triangular, where the longitudinal beams comprise a plurality of supporting grommets for fixing the supporting rings of the ventral supporting assembly and the sleeves, and above, at least a supporting grommet for hanging the assembly from a supporting hook linked to the lifting motor by a wire pulley.

47. The standing device according to claim 43, CHARACTERIZED in that the multiple cavities of the inflatable receptacles are filled with compressed air by means of at least one compressor, where the valves at the inlet of each conduit allow the air to enter and exit in a predetermined manner, thereby increasing and reducing the pressure within each receptacle.

48. The standing device according to claim 47, CHARACTERIZED in that the compressor has a compression capacity of 75 to 100 pounds/square inch and compresses air continuously on the valves which alternatively release a pressure of about 14/pounds/square inch every 3/10 minutes on a predetermined pattern in order to prevent the air release and to allow the air inlet so as to recover the pressure by starting a new cycle.

49. The standing device according to claim 47, CHARACTERIZED in that the inflatable receptacles are made of a resistant and air-retaining material selected from waterproof nylon fabric and a polyvinyl film, such as Panaflex.

50. The standing device according to any of claims 41 to 49, CHARACTERIZED in that the animal patient is an equine.

51. A harness for treatment and/or rehabilitation of an equine CHARACTERIZED by comprising several supporting points for the distributed weight of the animal, and which comprises several portions: a ventral supporting assembly which is substantially rectangular and consists in a plurality of layers of different kind and material, there being at least two independent inflatable receptacles between said layers, which receptacles comprise multiple cavities mutually linked to two interconnecting longitudinal conduits, and where said cavities are transversally and parallel disposed, in an alternate pattern, and cover the entire surface of the supporting assembly, where said cavities and conduits retain the air.

52. The harness for the treatment and/or rehabilitation of an equine according to claim 51, CHARACTERIZED in that the plurality of layers of the ventral supporting assembly of the harness for a quadruplet animal patient comprises, from the inner layer in contact with the animal patient towards the outer surface: a first basically-cotton fabric layer, of a canvas or denim/jean kind; a second layer made of felt, preferably made of wool fibers; a third layer formed by polyurethane foam rubber; a fourth layer formed by an assembly or at least two independent inflatable receptacles with multiple cavities linked to each other, made of a gas-proof film or fabric; a fifth layer formed by polyurethane foam rubber; a sixth layer formed by felt, preferably made of wool fibers; a seventh layer of basically wool fabric, of a canvas or denim/jean kind; and an eighth layer formed by a wound fabric with alternately intercrossed lines where a plurality of lines project, which end in the supporting rings, said lines being preferably of a nylon or like fabric, and where the different layers are sewed one to the other as a whole assembly.

53. The harness for the treatment and/or rehabilitation of an equine according to claim 52, CHARACTERIZED in that the plurality of side lines ending on corresponding supporting rings of said ventral supporting assembly is fixed to the bearings of a supporting frame.

54. The standing device according to claim 51, CHARACTERIZED in that, additionally, the harness comprises four substantially conical sleeves for supporting forearms and thighs of the animal patient, each sleeve comprising at least two lines ending on the corresponding supporting rings for fixing the sleeves to the supporting frame.

55. The standing device according to claim 54, CHARACTERIZED in that the sleeves are made of rubber fabric and polyurethane, and the lines are made of knitted nylon.

56. The standing device according to claim 53, CHARACTERIZED in that the supporting frame is formed by a series of beams and bearings constituting the corners and vertex of a regular prims having substantially rectangular base and walls and which front and rear base and sides and which front and rear faces are substantially triangular, where the longitudinal beams comprise a plurality of supporting grommets for fixing the supporting rings of the ventral supporting assembly and the sleeves, and above, at least a supporting grommet for hanging the assemble from a supporting hook linked to the lifting motor by a wire pulley.

57. The standing device according to claim 53, CHARACTERIZED in that the multiple cavities of the inflatable receptacles are filled with compressed air by means of at least one compressor, where the valves at the inlet of each conduit allow the air to enter and exit in a predetermined manner, thereby increasing and reducing the pressure within each receptacle.

58. The standing device according to claim 57, CHARACTERIZED in that the compressor has a compression capacity of 75 to 100 pounds/square inch and compresses air continuously on the valves which alternatively release a pressure of about 14/pounds/square inch every 3/10 minutes on a predetermined pattern in order to prevent the air release and to allow the air inlet to recover the pressure by starting a new cycle.

59. The standing device according to claim 57, CHARACTERIZED in that the inflatable receptacles are made of a resistant and air-retaining material selected from waterproof nylon fabric and a polyvinyl film, such as Panaflex.
